(19) United States
(12) Patent Application Publication
(10) Pub. No.: US 2018/0201271 A1
(43) Pub. Date: Jul. 19, 2018

(54) VEHICLE CONTROL DEVICE, VEHICLE CONTROL METHOD, AND VEHICLE CONTROL PROGRAM

(71) Applicant: HONDA MOTOR CO., LTD., Minato-ku, Tokyo (JP)

(72) Inventors: Atsushi Ishioka, Utsunomiya-shi (JP); Masanori Takeda, Tokyo (JP)

(21) Appl. No.: 15/742,601

(22) PCT Filed: Jul. 5, 2016
(86) PCT No.: PCT/JP2016/069866

§ 371 Date: Jan. 8, 2018

(30) Foreign Application Priority Data
Jul. 15, 2015 (JP) 2015-141383
Feb. 12, 2016 (JP) 2016-025271

(51) Int. Cl. B60W 30/18; B60W 30/12; G05D 1/02

(52) U.S. Cl. CPC B60W 30/18163; G05D 1/0214; B60W 30/12

(57) ABSTRACT

A vehicle control device includes a detection unit configured to detect a nearby vehicle traveling around a subject vehicle, and a target position candidate setting unit configured to set a lane change target position candidate in a target area as a candidate for a lane change target position set as a relative position with respect to the nearby vehicle traveling in an adjacent lane adjacent to a subject lane, by referring to a detection result of the detection unit, a number of lane change target position candidates varying according to a number of nearby vehicles traveling in the target area in the adjacent lane.

### TECHNICAL FIELD

The present invention relates to a vehicle control device, a vehicle control method, and a vehicle control program.

Priority is claimed on Japanese Patent Application Nos. 2015-141383, filed Jul. 15, 2015 and 2016-025271, filed Feb. 12, 2016, the content of which is incorporated herein by reference.

### BACKGROUND ART

In the related art, a recommended operation amount generation device for a vehicle including a nearby vehicle detection means that detects a nearby vehicle with respect to a subject vehicle, a vehicle state detection means that detects a state of the subject vehicle, a nearby vehicle behavior prediction means that predicts a behavior of the nearby vehicle, an evaluation function construction means that constructs an evaluation function for calculating a desirability of a driving operation for the subject vehicle from an output of the nearby vehicle detection means and an output of the vehicle state detection means, and a recommended operation amount calculation means that calculates an operation desirable for the subject vehicle from an output of the nearby vehicle behavior prediction means and an output of the evaluation function construction means is known (see, for example, Patent Literature 1). In this device, the nearby vehicle behavior prediction means includes a subject-vehicle model with a prediction response of the subject vehicle as an output, an other-vehicle model with a prediction response of the nearby vehicle as an output, and a vehicle information extraction function group for calculating information required for calculation of the subject-vehicle model and the other-vehicle model from information of a vehicle including the subject vehicle, and is configured by coupling the other-vehicle model and the subject-vehicle model in the vehicle information extraction function group.

### CITATION LIST

### Patent Literature

[Patent Literature 1]

Japanese Unexamined Patent Application, First Publication No. 2004-152125

### SUMMARY OF INVENTION

### Technical Problem

However, in the related art, the number of vehicles that are monitoring targets is limited in lane change, and only one target position for lane change can be set. As a result, a degree of freedom of lane change control may be lowered.

An aspect of the present invention has been made in view of such circumstances, and an object thereof is to provide a vehicle control device, a vehicle control method, and a vehicle control program capable of increasing a degree of freedom of lane change control.

### Solution to Problem

(1) A vehicle control device according to an aspect of the present invention includes a detection unit configured to detect a position of a nearby vehicle traveling around a subject vehicle; and a target position candidate setting unit configured to set a lane change target position candidate in a target area as a candidate for a lane change target position set as a relative position with respect to the nearby vehicle traveling in an adjacent lane adjacent to a subject lane, by referring to a detection result of the detection unit, a number of lane change target position candidates varying according to a number of nearby vehicles traveling in the target area in the adjacent lane.

(2) In the aspect (1), the target position candidate setting unit may set the lane change target position candidate between the nearby vehicles traveling in the target area.

(3) In the aspect (1) or (2), the target position candidate setting unit may set an area behind a front reference vehicle which is closest to the subject vehicle among the nearby vehicles traveling in the adjacent lane and traveling in front of a preceding vehicle traveling immediately in front of the subject vehicle in the subject lane, as the target area.

(4) In any one of the aspects (1) to (3), the target position candidate setting unit may set an area in front of a rear reference vehicle which is closest to the subject vehicle among the nearby vehicles traveling in the adjacent lane and traveling behind a following vehicle traveling immediately behind the subject vehicle in the subject lane, as the target area.

(5) In any one of the aspects (1) to (4), the vehicle control device may further include a virtual vehicle setting unit configured to set a virtual vehicle obtained by virtually simulating the nearby vehicle on a lane that is a lane change destination of the subject vehicle, and the target position candidate setting unit may regard the virtual vehicle set by the virtual vehicle setting unit as the nearby vehicle and set the lane change target position candidate within the target area.

(6) In the aspect (5), the vehicle control device may include an estimation unit configured to estimate whether or not the nearby vehicle is about to change lanes, and the virtual vehicle setting unit may set the virtual vehicle when the estimation unit estimates that the nearby vehicle is about to change lane to the lane that is the lane change destination of the subject vehicle.

(7) In the aspect (6), the virtual vehicle setting unit may set the virtual vehicle when the estimation unit estimates that a nearby vehicle present in a lane different from the lane in which the subject vehicle travels is about to change a lane to the lane that is the lane change destination of the subject vehicle.

(8) A vehicle control device according to an aspect of the present invention includes: a detection unit configured to detect a position of a nearby vehicle traveling around a subject vehicle; an estimation unit configured to estimate whether or not a nearby vehicle present on a lane different from a lane on which the subject vehicle travels detected by the detection unit is about to change a lane to a lane that is a lane change destination of the subject vehicle; a virtual vehicle setting unit configured to set a virtual vehicle obtained by virtually simulating the nearby vehicle on the lane that is the lane change destination of the subject vehicle when the estimation unit estimates that the nearby vehicle is about to change lane; and a target position candidate setting unit configured to set a lane change target position candidate in front of or behind the virtual vehicle as a candidate for a lane change target position set in an adjacent lane adjacent to a subject lane by referring to a detection result of the detection unit and the virtual vehicle set by the virtual vehicle setting unit.

(9) A vehicle control method according to an aspect of the present invention includes detecting a position of a nearby vehicle traveling around a subject vehicle; and setting a lane change target position candidate in a target area as a candidate for a lane change target position set as a relative position with respect to the nearby vehicle traveling in an adjacent lane adjacent to a subject lane, by referring to a detection result, a number of lane change target position candidates varying according to a number of nearby vehicles traveling in the target area in the adjacent lane.

(10) A vehicle control program according to an aspect of the present invention includes causing a computer of a vehicle control device including a detection unit configured to detect a position of a nearby vehicle traveling around a subject vehicle to execute: setting a lane change target position candidate in a target area as a candidate for a lane change target position set as a relative position with respect to the nearby vehicle traveling in an adjacent lane adjacent to a subject lane, by referring to a detection result of the detection unit, a number of lane change target position candidates varying according to a number of nearby vehicles traveling in the target area in the adjacent lane.

(11) A vehicle control device according to an aspect of the present invention includes: a detection unit configured to detect a position of a nearby vehicle traveling around a subject vehicle; and a target position candidate setting unit configured to set a target area for setting a candidate for a lane change target position set as a relative position with respect to the nearby vehicle traveling in an adjacent lane adjacent to a subject lane, by referring to a detection result of the detection unit, to an area being behind a front reference vehicle which is closest to the subject vehicle among the nearby vehicles traveling in the adjacent lane and traveling in front of a preceding vehicle traveling immediately in front of the subject vehicle in the subject lane, the area also being in front of a rear reference vehicle which is closest to the subject vehicle among the nearby vehicles traveling in the adjacent lane and traveling behind a following vehicle traveling immediately behind the subject vehicle in the subject lane.

### Advantageous Effects of Invention

According to the aspects (1), (2), (9) and (10), it is possible to increase a degree of freedom of lane change control by setting a lane change target position candidate in a target area as a candidate for a lane change target position set as a relative position with respect to the nearby vehicle traveling in an adjacent lane adjacent to a subject lane, the number of lane change target position candidates varying according to the number of nearby vehicles traveling in the target area in the adjacent lane.

According to the aspect (3), it is possible to prevent the lane change target position candidate from being set in front of the front reference vehicle, that is, at a position considered to be difficult to change lanes, by setting the area behind the front reference vehicle which is closest to the subject vehicle among the nearby vehicles traveling in the adjacent lane and traveling in front of a preceding vehicle traveling immediately in front of the subject vehicle in the subject lane, as the target area.

According to the aspect (4), it is possible to prevent the lane change target position candidate from being set behind the rear reference vehicle, that is, at a position considered to be difficult to change lanes.

According to the aspects (5) to (7), it is possible to prevent the lane change target position candidate from being set at a position considered to be difficult to change lane to by regarding the virtual vehicle as the nearby vehicle and setting the lane change target position candidate within the target area.

According to the aspect (8), it is possible to prevent the lane change target position candidate from being set at a position considered to be difficult to change lane and to increase a degree of freedom of the lane change control by setting the lane change target position candidate set in the adjacent lane adjacent to the subject lane in front of or behind the virtual vehicle.

According to the aspect (11), it is possible to prevent the lane change target position candidate from being set at a position considered to be difficult to change lanes, such as in front of the front reference vehicle or behind the rear reference vehicle, by setting the target area for setting the candidate for the lane change target position set as the relative position with respect to the nearby vehicle traveling in the adjacent lane adjacent to the subject lane, to an area being behind the front reference vehicle which is closest to the subject vehicle among the nearby vehicles traveling in the adjacent lane and traveling in front of a preceding vehicle traveling immediately in front of the subject vehicle in the subject lane, the area also being in front of a rear reference vehicle which is closest to the subject vehicle among the nearby vehicles traveling in the adjacent lane and traveling behind a following vehicle traveling immediately behind the subject vehicle in the subject lane.

### BRIEF DESCRIPTION OF DRAWINGS

FIG. 1 is a diagram illustrating components included in a vehicle (subject vehicle) on which a vehicle control device according to a first embodiment is mounted.

FIG. 2 is a functional configuration diagram of a subject vehicle including the vehicle control device according to the first embodiment.

FIG. 3 is a diagram illustrating a state in which a relative position of the subject vehicle with respect to a travel lane is recognized by a subject-vehicle position recognition unit.

FIG. 4 is a diagram illustrating an example of an action plan generated for a certain section.

FIG. 5 is a diagram illustrating a state in which a target position candidate setting unit sets lane change target position candidates.

FIG. 6 is a diagram illustrating a process that is executed by the target position candidate setting unit when a front reference vehicle is not detected.

FIG. 7 is a diagram illustrating a process that is executed by the target position candidate setting unit when a rear reference vehicle is not detected.

FIG. 8 is a diagram illustrating a process that is executed by the target position candidate setting unit when a preceding vehicle is not detected.

FIG. 9 is a diagram illustrating a process that is executed by the target position candidate setting unit when a following vehicle is not detected.

FIG. 10 is a diagram illustrating a process that is executed by the target position candidate setting unit when it is defined that a front reference vehicle and a rear reference vehicle are not included in a target area.

FIG. 11 is a diagram illustrating a positional relationship between monitoring target vehicles, and a subject vehicle and a lane change target position candidate.

FIG. 12 is a flowchart illustrating an example of a flow of a process of determining a lane change target position.

FIG. 13 is a diagram illustrating patterns obtained by categorizing a positional relationship between the subject vehicle and the monitoring target vehicles.

FIG. 14 is a diagram illustrating patterns obtained by categorizing a change in positions of monitoring target vehicles in pattern (a).

FIG. 15 is a diagram illustrating patterns obtained by categorizing a change in positions of monitoring target vehicles in pattern (b).

FIG. 16 is a diagram illustrating patterns obtained by categorizing a change in positions of monitoring target vehicles in pattern (c).

FIG. 17 is a diagram illustrating patterns obtained by categorizing a change in positions of monitoring target vehicles in pattern (d).

FIG. 18 is a diagram illustrating patterns obtained by categorizing a change in positions of monitoring target vehicles in pattern (e).

FIG. 19 is a diagram illustrating patterns obtained by categorizing a change in positions of monitoring target vehicles in pattern (f).

FIG. 20 is a flowchart illustrating an example of a flow of a process that is executed by a lane changeable period derivation unit.

FIG. 21 is a diagram illustrating an example of a control plan for lane change that is generated by a control plan generation unit.

FIG. 22 is a diagram illustrating a functional configuration of a vehicle control device including a travel aspect determination unit and a travel trajectory generation unit.

FIG. 23 is a diagram illustrating an example of a trajectory that is generated by the travel trajectory generation unit.

FIG. 24 is a functional configuration diagram of a subject vehicle including a vehicle control device according to a second embodiment.

FIG. 25 is a flowchart illustrating an example of a flow of a process that is executed by a lane change possibility determination unit according to the second embodiment.

FIG. 26 is a functional configuration diagram of a subject vehicle including a vehicle control device according to a third embodiment.

FIG. 27 is a functional configuration diagram of a subject vehicle including a vehicle control device according to a fourth embodiment.

FIG. 28 is a diagram illustrating a state in which a target position candidate setting unit of the fourth embodiment sets lane change target position candidates.

FIG. 29 is a diagram illustrating a state in which the target position candidate setting unit sets a lane change target position candidate when a virtual vehicle is set.

FIG. 30 is a diagram illustrating a state in which the target position candidate setting unit sets the lane change target position candidate when a nearby vehicle is not traveling in an adjacent lane.

FIG. 31 is a diagram illustrating a state in which the target position candidate setting unit sets a lane change target position candidate when a virtual vehicle is set.

FIG. 32 is a diagram illustrating a state in which the target position candidate setting unit sets a lane change target position candidate when vehicle is set.

FIG. 33 is a diagram illustrating a state in which the target position candidate setting unit sets the lane change target position candidate before the lane disappears.

FIG. 34 is a diagram illustrating a state in which the target position candidate setting unit sets the lane change target position candidate when an arrival time at which the vehicle arrives at a point is within a predetermined value.

### DESCRIPTION OF EMBODIMENTS

Hereinafter, embodiments of a vehicle control device, a vehicle control method, and a vehicle control program according to the present invention will be described with reference to the drawings.

### First Embodiment

### Vehicle Configuration

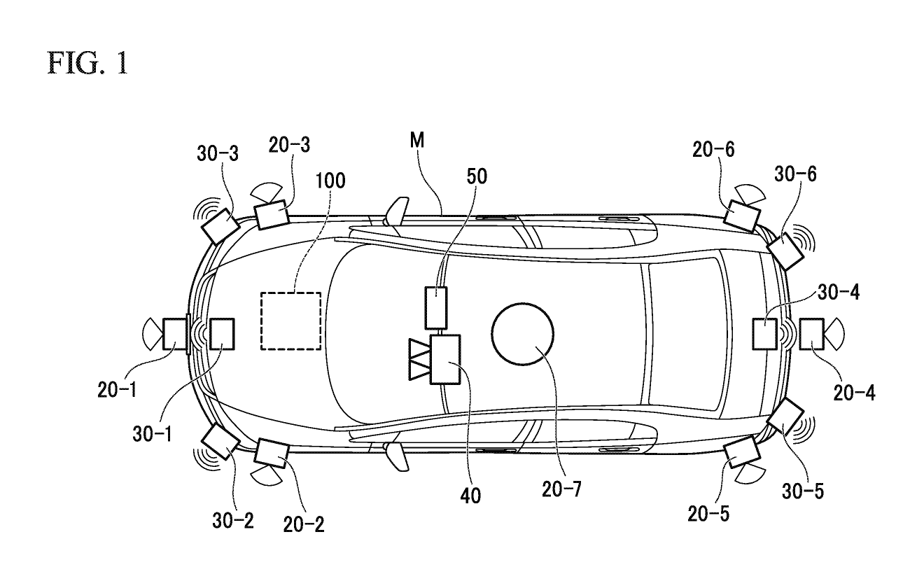

FIG. 1 is a diagram illustrating components included in a vehicle on which a vehicle control device 100 according to a first embodiment is mounted (hereinafter referred to as a subject vehicle M). The vehicle on which the vehicle control device 100 is mounted is, for example, a two-wheeled vehicle, a three-wheeled vehicle, or a four-wheeled vehicle, and includes a vehicle using an internal combustion engine such as a diesel engine or a gasoline engine as a power source, an electric vehicle using an electric motor as a power source, a hybrid vehicle with an internal combustion engine and an electric motor, and the like. Further, the above-described electric vehicle is driven using electric power that is discharged by a battery such as a secondary battery, a hydrogen fuel cell, a metal fuel cell, or an alcohol fuel cell, for example.

As illustrated in FIG. 1, sensors such as finders 20-1 to 20-7, radars 30-1 to 30-6, and a camera 40, a navigation device 50, and a vehicle control device 100 described above are mounted on the vehicle. The finder 20-1 to 20-7 are, for example, a light detection and ranging or laser imaging detection and ranging (LIDAR) that measures scattered light with respect to irradiation light and measures a distance to a target. For example, the finder 20-1 is attached to a front grill or the like, and the finders 20-2 and 20-3 are attached to a side surface of a vehicle body, a door mirror, the inside of a headlight, the vicinity of side lamps, and the like. The finder 20-4 is attached to a trunk lid or the like, and the finders 20-5 and 20-6 are attached to the side surface of the vehicle body, the inside of a taillight, or the like. For example, the finders 20-1 to 20-6 described above have a detection range of about 150° with respect to a horizontal direction. Further, the finder 20-7 is attached to a roof or the like. For example, the finder 20-7 has a detection range of 360° with respect to the horizontal direction.

The radars 30-1 and 30-4 described above are, for example, long-distance millimeter-wave radars of which the detection range in a depth direction is wider than that of other radars. Further, the radars 30-2, 30-3, 30-5, and 30-6 are intermediate-distance millimeter wave radars of which the detection range in the depth direction is narrower than that of the radars 30-1 and 30-4. Hereinafter, the finders 20-1 to 20-7 are simply referred to as a “finder 20” when not particularly distinguished, and the radars 30-1 to 30-6 are simply referred to as a “radar 30” when not particularly distinguished. The radar 30 detects an object rising, for example, a frequency modulated continuous (FM-CW) scheme.

The camera 40 is, for example, a digital camera using a solid-state imaging device such as a charge coupled device (CCD) or a complementary metal oxide semiconductor (CMOS). The camera 40 is attached to an upper portion of a front windshield, a rear surface of a rearview mirror, or the like. For example, the camera 40 periodically repeatedly images in front of the subject vehicle M.

The configuration illustrated in FIG. 1 is merely an example, and part of the configuration may be omitted or another configuration may be added.

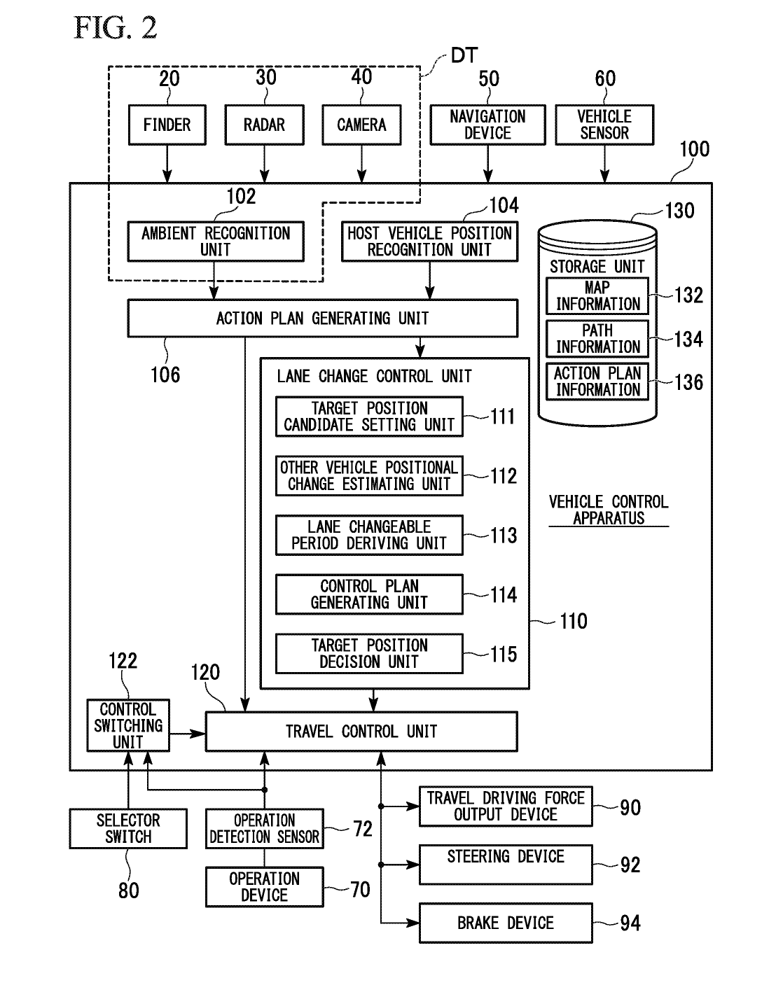

FIG. 2 is a functional configuration diagram of the subject vehicle M including the vehicle control device 100 according to the first embodiment. A navigation device 50, a vehicle sensor 60, an operation device 70, an operation detection sensor 72, a changeover switch 80, a travel driving force output device 90, a steering device 92, a brake device 94, and a vehicle control device 100 are mounted on the subject vehicle M, in addition to the finder 20, the radar 30, and the camera 40.

The navigation device 50 includes a global navigation satellite system (GNSS) receiver or map information (navigation map), a touch panel type display device functioning as a user interface, a speaker, a microphone, and the like. The navigation device 50 specifies a position of the subject vehicle M using the GNSS receiver and derives a route from the position to a destination designated by the user. The route derived by the navigation device 50 is stored in a storage unit 130 as route information 134. The position of the subject vehicle M may be identified or supplemented by an inertial navigation system (INS) using the output of the vehicle sensor 60. Further, when the vehicle control device 100 is executing a manual driving mode, the navigation device 50 performs guidance through voice or a navigation display for the route to the destination. A configuration for specifying the position of the subject vehicle M may be provided independently of the navigation device 50. Further, the navigation device 50 may be realized, for example, by a function of a terminal device such as a smartphone or a tablet terminal possessed by the user. In this case, transmission and reception of information is performed between the terminal device and the vehicle control device 100 through wireless or communication.

The vehicle sensor 60 includes a vehicle speed sensor that detects a speed of the subject vehicle M (vehicle speed), an acceleration sensor that detects an acceleration, a yaw rate sensor that detects an angular velocity around a vertical axis, and a direction sensor that detects a direction of the subject vehicle M.

The operation device 70 includes, for example, an accelerator pedal, a steering wheel, a brake pedal, a shift lever, and the like. The operation detection sensor 72 that detects the presence or absence or the amount of an operation of the driver is attached to the operation device 70. The operation detection sensor 72 includes, for example, an accelerator opening degree sensor, a steering torque sensor, a brake sensor, a shift position sensor, and the like. The operation detection sensor 72 outputs a degree of accelerator opening, a steering torque, a brake pedal amount, a shift position, and the like as detection results to the travel control unit 120. Alternatively, the detection result of the operation detection sensor 72 may be directly output to the travel driving force output device 90, the steering device 92, or the brake device 94.

The changeover switch 80 is a switch that is operated by a driver or the like. The changeover switch 80 may be a mechanical switch or may be a graphical user interface (GUI) switch that is provided in the touch panel type display device of the navigation device 50. The changeover switch 80 receives a switching instruction to switch between a manual driving mode in which the driver manually drives and an automatic driving mode in which the vehicles travels in a state in which the driver does not perform operations (or the amount of an operation is smaller than in the manual driving mode or an operation frequency is lower than that in the manual driving mode), and generates a control mode designation signal for designating a control mode of the travel control unit 120 as any one of the automatic driving mode and the manual driving mode.

The travel driving force output device 90 includes, for example, one or both of an engine and a traveling motor. When the travel driving force output device 90 includes only an engine, the travel driving force output device 90 further includes an engine electronic control unit (ECU) that controls the engine. The engine ECU controls the travel driving force (torque) for causing the vehicle to travel, for example, by adjusting a degree of throttle opening, a shift stage, or the like according to information input from the travel control unit 120. When the travel driving force output device 90 includes only a traveling motor, the travel driving force output device 90 includes a motor ECU that drives the traveling motor. The motor ECU controls the travel driving force for causing the vehicle to travel, for example, by adjusting a duty ratio of a PWM signal to be applied to the traveling motor. When the travel driving force output device 90 includes both an engine and a traveling motor, both an engine ECU and a motor ECU cooperate to control the travel driving force.

The steering device 92 includes, for example, an electric motor that can change directions of steered wheels by applying a force on a rack and pinion facility or the like, a steering angle sensor that detects a steering angle (or actual steering angle), and the like. The steering device 92 drives the electric motor according to information input from the travel control unit 120.

The brake device 94 includes a master cylinder to which a brake operation of the brake pedal is transmitted as hydraulic pressure, a reservoir tank that stores brake fluid, a brake actuator that adjusts a braking force that is output to each wheel, and the like. The brake device 94 controls the brake actuator or the like so that a brake torque having a desired magnitude is output to each wheel according to information input from the travel control unit 120. The brake device 94 is not limited to an electronic control brake device that is operated by the above-described hydraulic pressure, and may be an electronic control brake device that is operated by an electric actuator.

### Vehicle Control Device

Hereinafter, the vehicle control device 100 will be described. The vehicle control device 100 includes, for example, an outside world recognition unit 102, a subject-vehicle position recognition unit 104, an action plan generation unit 106, a lane change control unit 110, a travel control unit 120, a control switching unit 122, and a storage unit 130. Some or all of the outside world recognition unit 102, the subject-vehicle position recognition unit 104, the action plan generation unit 106, the lane change control unit 110, the travel control unit 120, and the control switching unit 122 may be software functional units that function by a processor such as a central processing unit (CPU) executing a program. Further, some or all of these may be hardware functional units such as large scale integration (LSI) or application specific integrated circuit (ASIC). Further, the storage unit 130 is realized by a read only memory (ROM), a random access memory (RAM), a hard disk drive (HDD), a flash memory, or the like. The program may be stored in the storage unit 130 in advance or may be downloaded from an external device via an in-vehicle Internet facility or the like. Further, a portable storage medium having the program stored thereon may be installed in the storage unit 130 by being mounted on a drive device (not illustrated).

The outside world recognition unit 102 recognizes a state such as a position and a speed of a nearby vehicle on the basis of outputs of the finder 20, the radar 30, the camera 40, and the like. The nearby vehicle in this embodiment is a vehicle that travels around the subject vehicle M and is a vehicle that travels in the same direction as that of the subject vehicle M. The position of the nearby vehicle may be represented by a representative point such as a centroid or a corner of another vehicle or may be represented by an area expressed by an outline of another vehicle. The “state” of the nearby vehicle may include an acceleration of the nearby vehicle, and an indication of whether or not the nearby vehicle is changing lane (or whether or not the nearby vehicle is about to change lane) on the basis of the information of various devices described above. The outside world recognition unit 102 recognizes whether or not the nearby vehicle is changing lane (or whether or not the nearby vehicle is about to change lane) based on the history of the position of the nearby vehicle, the operation state of the direction indicator, or the like. Further, in addition to nearby vehicles, the outside world recognition unit 102 may also recognize a position of a guardrail, a utility pole, a parked vehicle, a pedestrian, and other objects. Hereinafter, a combination of the finder 20, the radar 30, the camera 40, and the outside world recognition unit 102 is referred to as a “detection unit DT” that detects a nearby vehicle. The detection unit DT may further recognize a state of a position, a speed, or the like of a nearby vehicle through communication with the nearby vehicle.

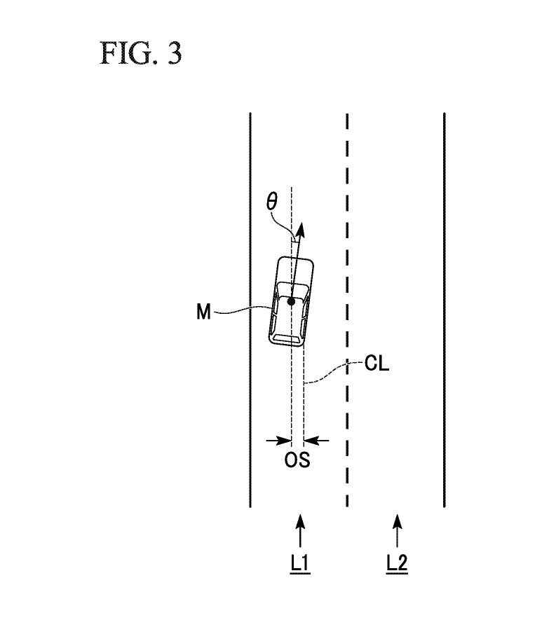

The subject-vehicle position recognition unit 104 recognizes a lane (subject lane) which the subject vehicle M is traveling, and a relative position of the subject vehicle M with respect to the travel lane on the basis of map information 132 stored in the storage unit 130, and information input from the finder 20, the radar 30, the camera 40, the navigation device 50, or the vehicle sensor 60. The map information 132 is, for example, map information with higher accuracy than the navigation map included in the navigation device 50, and includes information on a center of the lane or information on boundaries of the lane. FIG. 3 is a diagram illustrating a state in which the relative position of the subject vehicle M with respect to the travel lane is recognized by the subject-vehicle position recognition unit 104. The subject-vehicle position recognition unit 104, for example, may recognize a deviation OS of the reference point (for example, the centroid) of the subject vehicle M from a travel lane center CL, and an angle θ with respect to a line connecting the travel lane center CL in the travel direction of the subject vehicle M, as the relative position of the subject vehicle M with respect to the travel lane. Instead of this, the subject-vehicle position recognition unit 104 may recognize, for example, the position of the reference point of the subject vehicle M with respect to one of side end portions of the subject lane L1 as the relative position of the subject vehicle M with respect to the travel lane.

The action plan generation unit 106 generates an action plan in a predetermined section. The predetermined section is, for example, a section passing through a toll road such as a highway in a route derived by the navigation device 50. The present invention is not limited thereto, and the action plan generation unit 106 may generate an action plan for an arbitrary section.

The action plan includes, for example, a plurality of events that are executed sequentially. Examples of the events include a deceleration event for decelerating the subject vehicle M, an acceleration event for accelerating the subject vehicle M, a lane keeping event for causing the subject vehicle M to travel so that the subject vehicle M does not deviate from a travel lane, a lane change event for changing travel lane, an overtaking event for causing the subject vehicle M to overtake a preceding vehicle, a branch event for changing a lane to a desired lane at a branch point or causing the subject vehicle M to travel so that the subject vehicle M does not deviate from a current travel lane, and a merging event for accelerating and decelerating the subject vehicle M at a lane merging point and changing the driving lane. For example, when there is a junction (a branch point) in a toll road (for example, a highway), it is necessary for the vehicle control device 100 to change lanes so that the subject vehicle M travels in the direction of the destination or keep in a lane in the automatic driving mode. Accordingly, when it is determined that there is a junction on a route by referring to the map information 132, the action plan generation unit 106 sets a lane change event for changing lane to a desired lane in which the vehicle can proceed in the direction of the destination, between the current position (coordinates) of the subject vehicle M and the position (coordinates) of the junction.

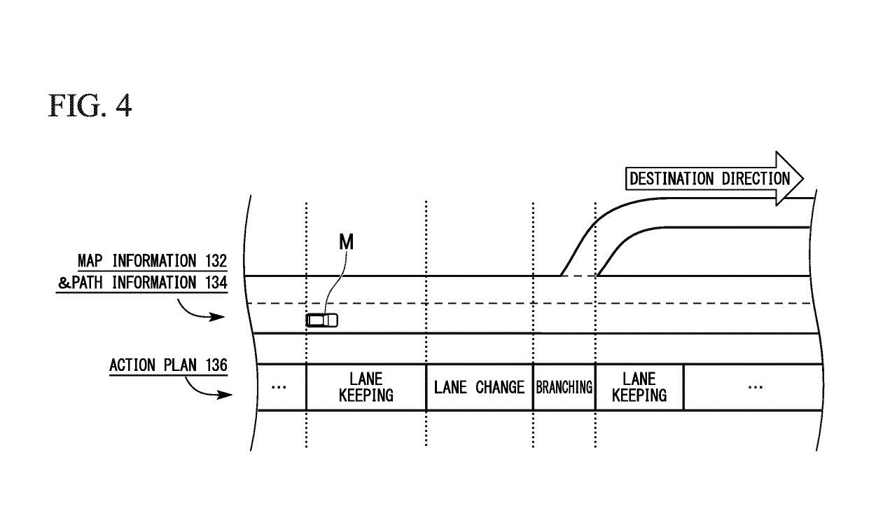

FIG. 4 is a diagram illustrating an example of an action plan generated for a certain section. As illustrated in FIG. 4, the action plan generation unit 106 classifies scenes that are generated when the vehicle travels along a route to a destination, and generates an action plan so that an event suitable for each scene is executed. The action plan generation unit 106 may dynamically change the action plan according to a change in a situation of the subject vehicle M.

### Lane Change Event

The lane change control unit 110 performs control when the lane change event included in the action plan by the action plan generation unit 106 is performed. The lane change control unit 110 includes, for example, a target position candidate setting unit 111, an other-vehicle position change estimation unit 112, a lane changeable period derivation unit 113, a control plan generation unit 114, and a target position determination unit 115.

### (Setting of Target Position Candidates)

The target position candidate setting unit 111 refers to the position of the nearby vehicle detected by the detection unit DT to first set a target area of a large frame that is a lane change target, and set the lane change target position candidate as a relative position with respect to the nearby vehicle traveling in an adjacent lane adjacent to the travel lane (subject lane) which the subject vehicle M travels within the target area.

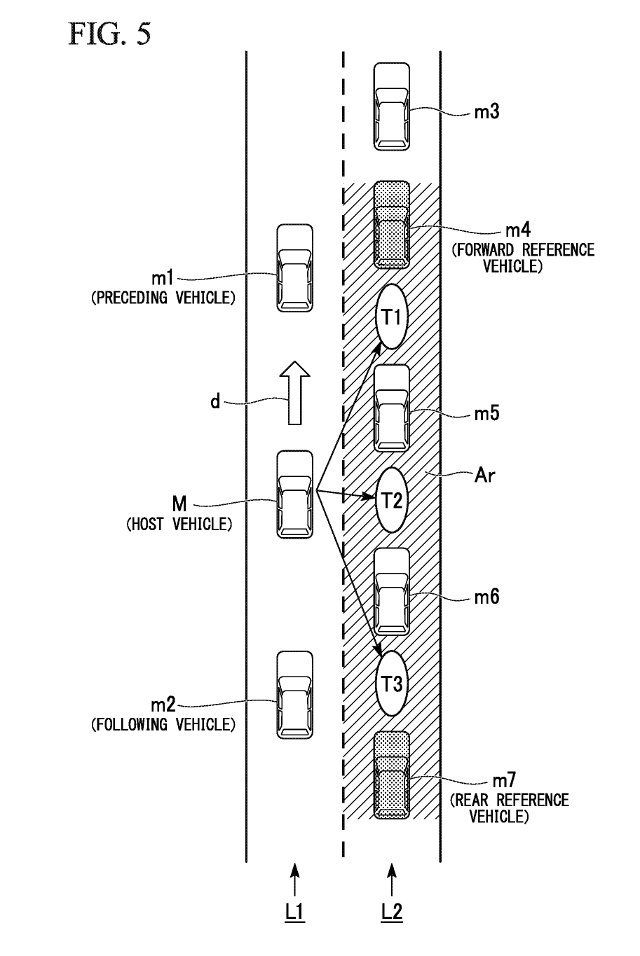

FIG. 5 is a diagram illustrating a state in which the target position candidate setting unit 111 sets a lane change target position candidate. In FIG. 5, m1 to m7 are nearby vehicles, d is a travel direction of each vehicle, L1 is the subject lane, and L2 is an adjacent lane. Further, Ar is a target area, and T1 to T3 are lane change target position candidates. The lane change target position candidates are simply referred to as a lane change target position candidate T unless otherwise distinguished. In the following description, it is assumed that changing lane to the adjacent lane L2 extending to the right side of the subject lane L1 is instructed by the action plan.

First, the target position candidate setting unit 111 sets, as the target area Ar, an area being behind a nearby vehicle m4 (a front reference vehicle) which is closest to the subject vehicle M among the nearby vehicles traveling in the adjacent lane L2 and traveling in front of a nearby vehicle m1 (a preceding vehicle) traveling immediately in front of the subject vehicle M in the subject lane L1, the area also being in front of a nearby vehicle m7 (a rear reference vehicle) which is closest to the subject vehicle M among the nearby vehicles traveling in the adjacent lane L2 and traveling behind the nearby vehicle m2 (a following vehicle) traveling immediately behind the subject vehicle M in the subject lane L1.

Here, the “nearby vehicle traveling in front of the preceding vehicle” may mean a nearby vehicle of which a front end portion is in front of a front end portion of the preceding vehicle or may mean a nearby vehicle of which a rear end portion is in front of a rear end portion of the preceding vehicle. Further, the “nearby vehicle traveling in front of the preceding vehicle” may mean a nearby vehicle of which a reference point such as a centroid is located in front of the reference point, the front end portion, or the rear end portion of the preceding vehicle.

On the other hand, a “nearby vehicle traveling behind a following vehicle” may mean a nearby vehicle of which a front end portion is behind a front end portion of the following vehicle or may mean a nearby vehicle of which a rear end portion is behind a rear end portion of the following vehicle. Further, the “nearby vehicle traveling behind the following vehicle” may mean a nearby vehicle of which a reference point such as a centroid is located behind the reference point, the front end portion, or the rear end portion of the following vehicle.

Accordingly, the target position candidate setting unit 111 can prevent the lane change target position candidate T from being set to a position considered difficult to change a lane to, such as in front of a nearby vehicle traveling in front of the preceding vehicle or behind a nearby vehicle traveling behind the following vehicle. This is because a behavior of the subject vehicle M for lane change is greatly limited by a behavior of the preceding vehicle or the following vehicle at such a position. As a result, the target position candidate setting unit 111 can prevent the subject vehicle M from being forced into an unreasonable behavior at the time of lane change.

The target position candidate setting unit 111 sets the lane change target position candidates T1, T2, and T3 between two nearby vehicles (m4 and m5, m5 and m6, and m6 and m7) traveling in a relationship of immediately in front and immediately behind (in a relationship in which there is no nearby vehicle therebetween) among the nearby vehicles m4 to m7 traveling in the target area Ar. Therefore, the number of lane change target position candidates T is changed according to the number of nearby vehicles traveling in the target area Ar in the adjacent lane L2. When the number of nearby vehicles traveling in the target area Ar is n, n−1 lane change target position candidates T are set.

Accordingly, the target position candidate setting unit 111 sets a plurality of candidates of lane change destinations according to a distribution of the nearby vehicles, such that a degree of freedom of the lane change control can be increased. As a result, it is possible to set an optimal lane change target position T# later.

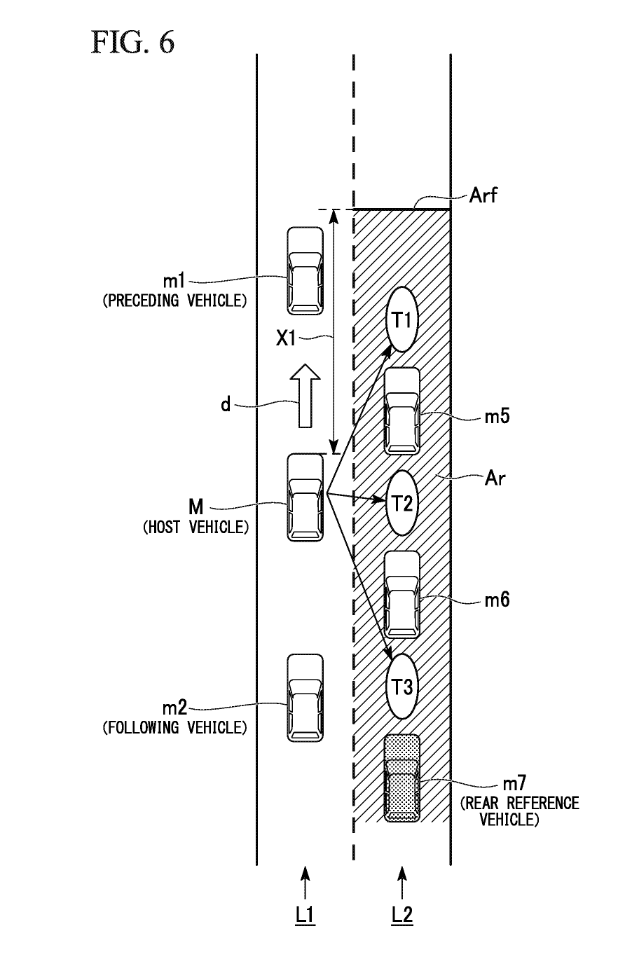

Here, it is also assumed that any one of the front reference vehicle, the rear reference vehicle, the preceding vehicle, and the following vehicle may not be detected by the detection unit DT. This will be described below. FIG. 6 is a diagram illustrating a process that is executed by the target position candidate setting unit 111 when a front reference vehicle is not detected. As illustrated in FIG. 6, when the front reference vehicle is not detected (when there is no nearby vehicle in front of the preceding vehicle), the target position candidate setting unit 111 determines, for example, a point at a predetermined distance X1 forward from the front end portion of the subject vehicle M to be a front side boundary Arf of the target area Ar. The predetermined distance X1 is set to a distance at which a nearby vehicle in front of the subject vehicle M can be detected, for example, by the finder 20, the radar 30, the camera 40, or the like. In this case, the target position candidate setting unit 111 may set the lane change target position candidate T1 not only between two nearby vehicles traveling in the relationship of immediately in front and immediately behind, but also between the front side boundary Arf of the target area Ar and the nearby vehicle m5 traveling at a foremost position in the target area Ar.

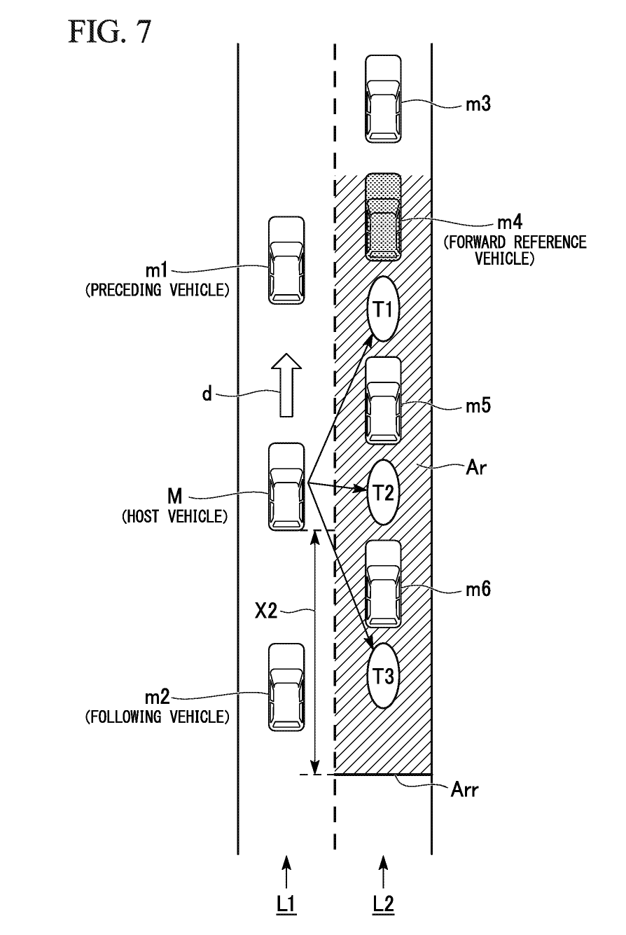

FIG. 7 is a diagram illustrating a process that is executed by the target position candidate setting unit 111 when a rear reference vehicle is not detected. As illustrated in FIG. 7, when a rear reference vehicle is not detected (when there is no nearby vehicle behind the following vehicle), the target position candidate setting unit 111 determines, for example, a point at a predetermined distance X2 to the rear of the rear end portion of the subject vehicle M to be a rear side boundary Arr of the target area Ar. The predetermined distance X2 is set to a distance at which a nearby vehicle behind the subject vehicle M can be detected, for example, by the finder 20, the radar 30, the camera 40, or the like. In this case, the target position candidate setting unit 111 may set the lane change target position candidate T3 not only between two nearby vehicles traveling in the relationship of immediately in front or immediately behind, but also between the rear side boundary Arr of the target area Ar and the nearby vehicle m6 traveling at a rearmost position in the target area Ar.

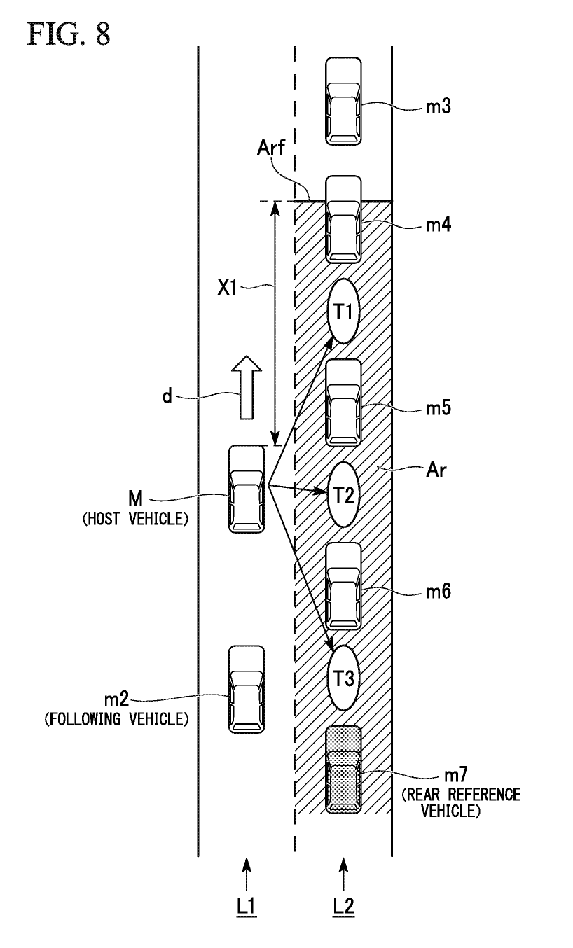

FIG. 8 is a diagram illustrating a process that is executed by the target position candidate setting unit 111 when a preceding vehicle is not detected. As illustrated in FIG. 8, when a preceding vehicle is not detected (when there is no nearby vehicle within a detection range of the detection unit DT in front of the subject vehicle M), the target position candidate setting unit 111 determines, for example, a point at a predetermined distance X1 forward from the front end portion of the subject vehicle M to he the front side boundary Arf of the target area Ar.

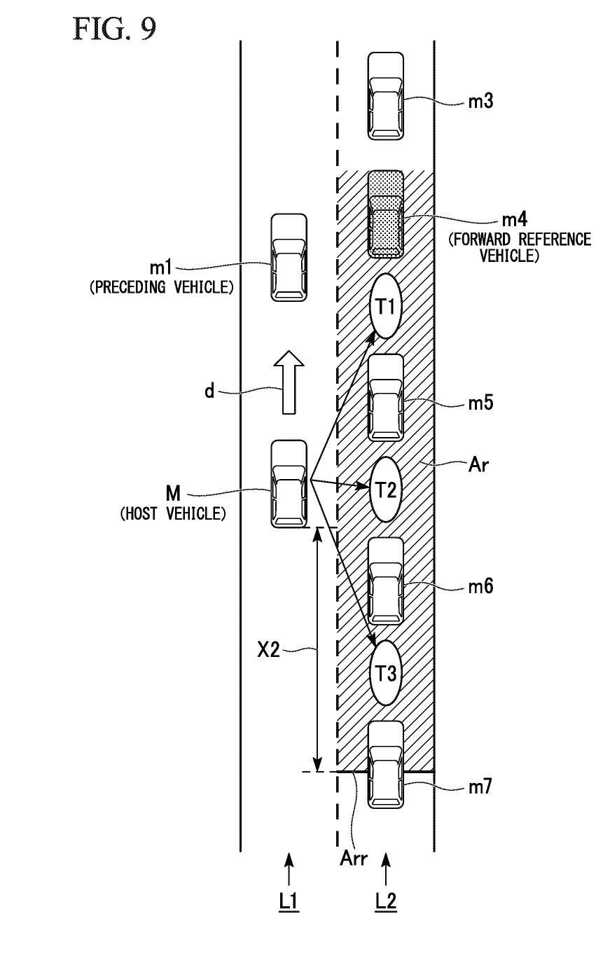

FIG. 9 is a diagram illustrating a process that is executed by the target position candidate setting unit 111 when a following vehicle is not detected. As illustrated in FIG. 9, when a following vehicle is not detected (when there is no nearby vehicle within the detection range of the detection unit DT behind the subject vehicle M), the target position candidate setting unit 111 determines, for example, a point at a predetermined distance X2 behind the rear end portion of the subject vehicle M to be the rear side boundary Arr of the target area Ar.

Although the front reference vehicle and the rear reference vehicle have been defined as being included in the target area Ar for convenience in the above description, the front reference vehicle and the rear reference vehicle may be defined as vehicles not included in the target area Ar and the process may be performed. In this case, the target position candidate setting unit 111 may set the lane change target position candidate T not only between two nearby vehicles traveling in a relationship of immediately in front or immediately behind (in a relationship in which there is no nearby vehicle therebetween), but also between the front side boundary Arf of the target area Ar and a nearby vehicle immediately behind the boundary and between the rear side boundary Arr of the target area Ar and a nearby vehicle immediately in front of the boundary.

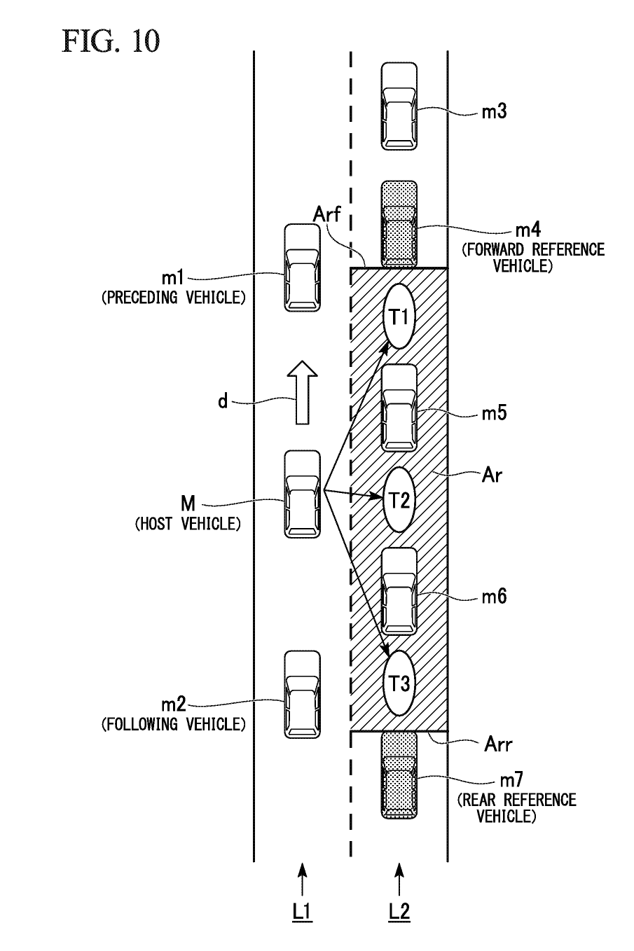

FIG. 10 is a diagram illustrating a process that is executed by the target position candidate setting unit 111 when the front reference vehicle and the rear reference vehicle are defined as not being included in the target area Ar. This process differs from the process illustrated in FIG. 5 in a process of setting the lane change target position candidate T, but results are the same and these processes have a relationship of being equivalent.

The other-vehicle position change estimation unit 112 selects nearby vehicles (three nearby vehicles in the following example) that are highly likely to interfere with the lane change among the nearby vehicles detected by the detection unit DT, and estimates a future change in a position of the selected vehicle. Hereinafter, the nearby vehicles highly likely to interfere with the lane change are referred to as monitoring target vehicles mA, mB, and mC.

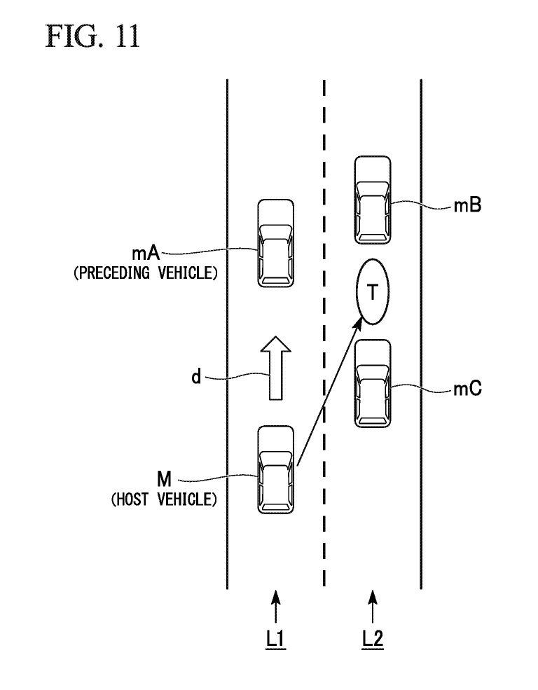

FIG. 11 is a diagram illustrating a positional relationship between the monitoring target vehicles and the subject vehicle, and the lane change target position candidate T. The monitoring target vehicle mA is a vehicle preceding the subject vehicle M. Further, the monitoring target vehicle mB is a nearby vehicle traveling immediately in front of the lane change target position candidate T, and the monitoring target vehicle mC is a nearby vehicle traveling immediately behind the lane change target position candidate T.

The lane changeable period derivation unit 113 derives a lane changeable period P for the lane change target position candidate T on the basis of the change in the positions of the monitoring target vehicles mA, mB, and mC estimated by the other-vehicle position change estimation unit 112. Process of the lane changeable period derivation unit 113 will be described in detail below.

The control plan generation unit 114 generates a control plan for a lane change on the basis of the change in the positions of the monitoring target vehicles mA, mB, and mC estimated by the other-vehicle position change estimation unit 112 for each lane change target position candidate T set by the target position candidate setting unit 111.

The target position determination unit 115 determines the lane change target position T# on the basis of the control plan generated by the control plan generation unit 114 for each lane change target position candidate T set by the target position candidate setting unit 111.

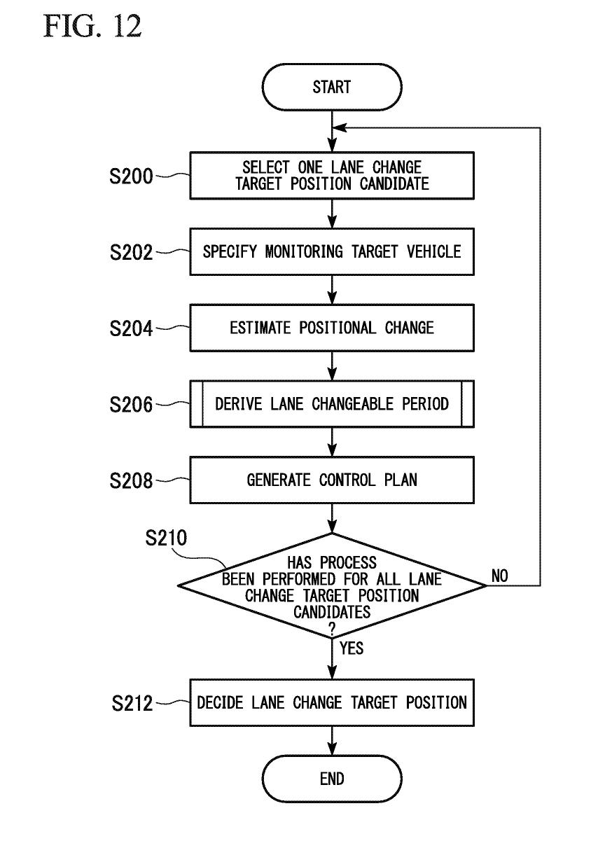

Hereinafter, a process of determining a lane change target position will be described with reference to the flowchart. FIG. 12 is a flowchart illustrating an example of a flow of a process of determining a lane change target position.

First, the target position candidate setting unit 111 selects one lane change target position candidate T (step S200). Then, the other-vehicle position change estimation unit 112 specifies the monitoring target vehicles mA, mB, and mC corresponding to the lane change target position candidate T (step S202; see FIG. 11).

Next, the other-vehicle position change estimation unit 112 estimates a future change in positions of the monitoring target vehicles mA, mB and mC (step S204).

The future change in the position can be estimated on the basis of various models such as a constant speed model in which a vehicle is assumed to travel while maintaining a current speed, and a constant acceleration model in which a vehicle is assumed to travel while maintaining the current acceleration. Further, the other-vehicle position change estimation unit 112 may consider a steering angle of the monitoring target vehicle, or may estimate the change in the position on the assumption that a vehicle is traveling while keeping in a current travel lane without considering the steering angle. In the following description, the monitoring target vehicle is assumed to travel while keeping in a travel lane and keeping a current speed, and the change in the position is estimated.

Then, the lane changeable period derivation unit 113 derives the lane changeable period P (step S206). The process will be described in detail below with reference to another flowchart, and a principle that is a basis of the process that is executed by the lane changeable period derivation unit 113 will first be described.

First, a relationship (position distribution) between the subject vehicle M and the monitoring target vehicles mA, mB, and mC is categorized into six patterns as shown below, for example. Hereinafter, a vehicle shown on the left-hand-side indicates a preceding vehicle. Patterns (a) and (b) show examples in which a lane is changed without changing a relative position with respect to nearby vehicles, pattern (c) shows an example in which a relative position with respect to the nearby vehicles is lowered (relatively decelerated) and the lane change is performed, and patterns (d), (e), and (f) show an example in which a relative position with respect to nearby vehicles is raised (relatively accelerated) and the lane change is performed.
Pattern (a): mA-mB-M-mC
Pattern (b): mB-mA-M-mC
Pattern (c): mA-M-mB-mC
Pattern (d): mA-mB-mC-M
Pattern (e): mB-mA-mC-M
Pattern (f): mB-mC-mA-M

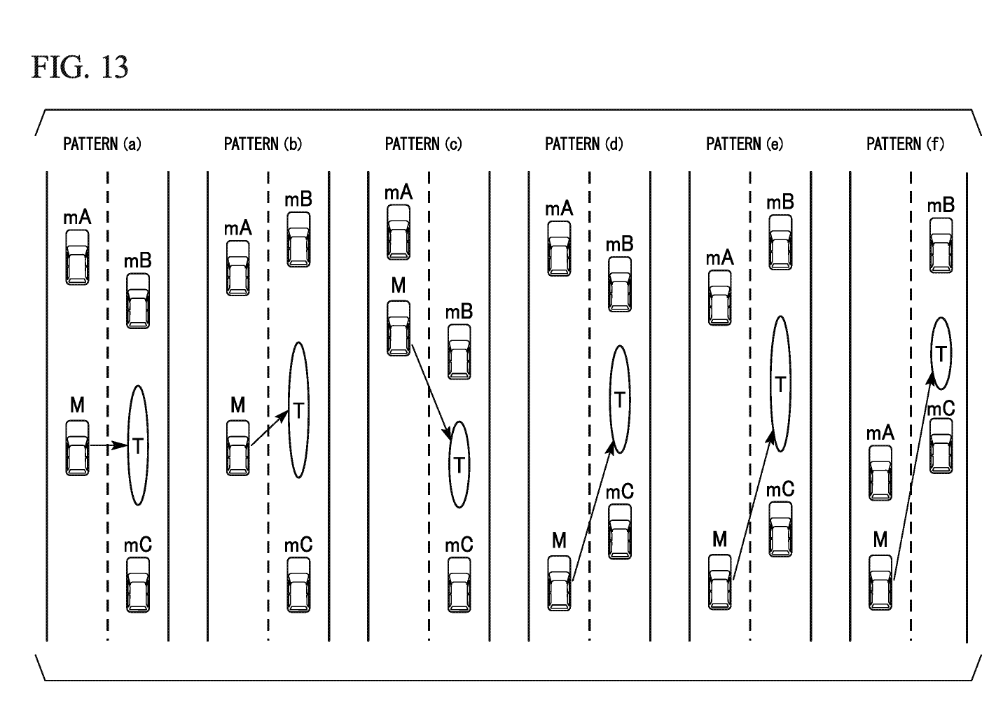

FIG. 13 is a diagram illustrating patterns obtained by categorizing the positional relationship between the subject vehicle and the monitoring target vehicles.

Since pattern (f) is based on the lane change target position candidate T not set by the target position candidate setting unit 111 in the first embodiment, pattern (f) is a reference example herein.

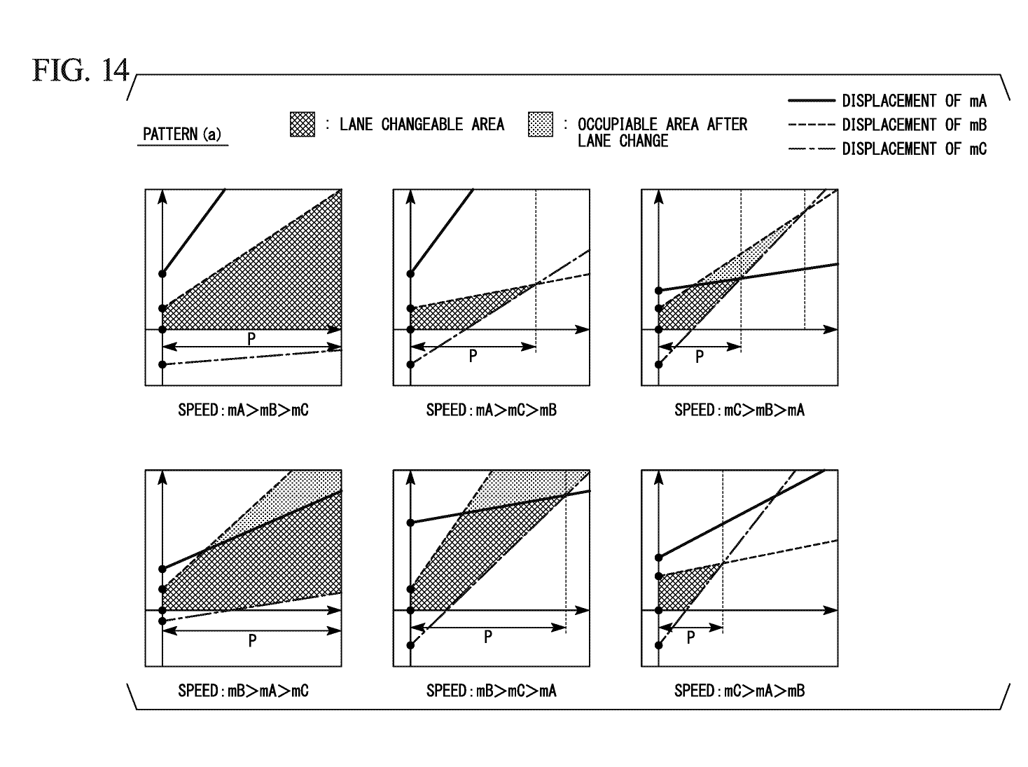

For respective patterns (a) to (f), the change in positions of the monitoring target vehicles mA, mB and mC is further categorized on the basis of the speed of the monitoring target vehicles. FIGS. 14 to 19 are diagrams illustrating respective patterns obtained by categorizing the change in the positions of the monitoring target vehicles for the respective patterns (a) to (f). In FIGS. 14 to 19, a vertical axis indicates displacement regarding a travel direction with respect to the subject vehicle M, and a horizontal axis indicates elapsed time. A presence possibility area after lane change in FIGS. 14 to 19 is an area of displacement in which the subject vehicle M can be present when the monitoring target vehicle continues to travel with the same trends after lane change is performed. For example, the diagram of “speed: mB>mA>mC” of FIG. 14 shows that a restriction applies so that the lane changeable area is below the displacement of the monitoring target vehicle mA, that is, the subject vehicle M may not be in front of the monitoring target vehicle mA before the lane change is performed, but there is no problem if the subject vehicle is in front of the monitoring target vehicle mA after the lane change is performed. The presence possibility area after lane change is used for a process of the control plan generation unit 114.

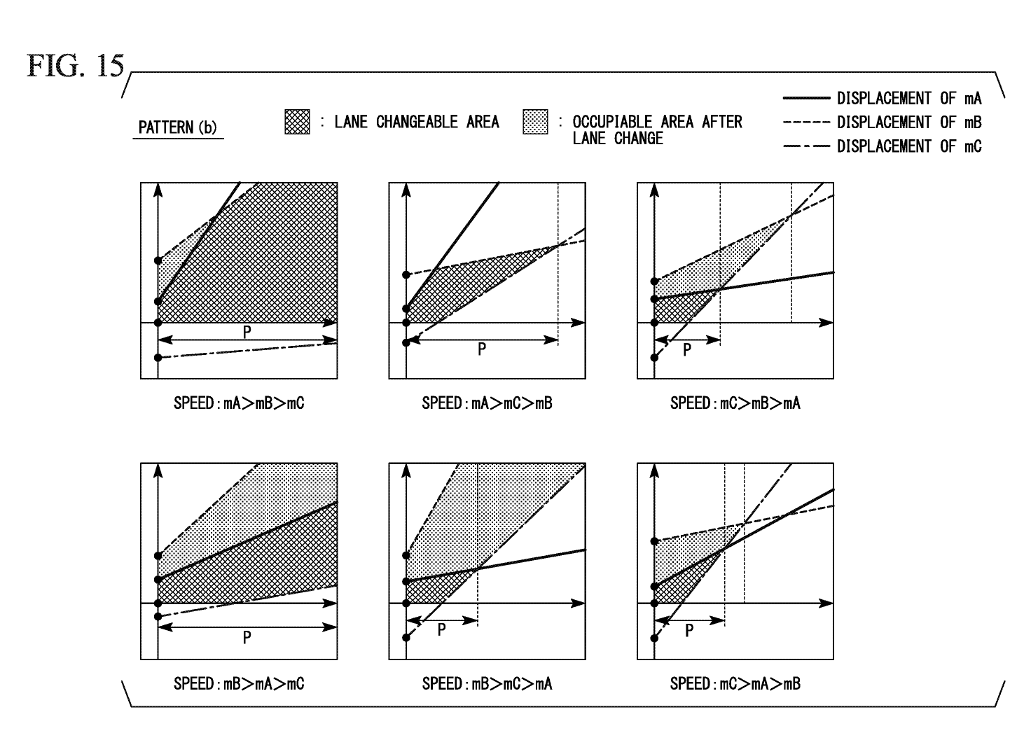

FIG. 14 is a diagram illustrating patterns obtained by categorizing a change in positions of the monitoring target vehicles in pattern (a). Further, FIG. 15 is a diagram illustrating patterns obtained by categorizing a change in positions of the monitoring target vehicles in pattern (b). The lane changeable period P in the patterns (a) and (b) is defined as follows (hereinafter “monitoring target vehicles” are omitted).

Start point in time: Any time

End point in time: An earlier point in time between a point in time at which mC catches up with mA or a point in time at which mC catches up with mB

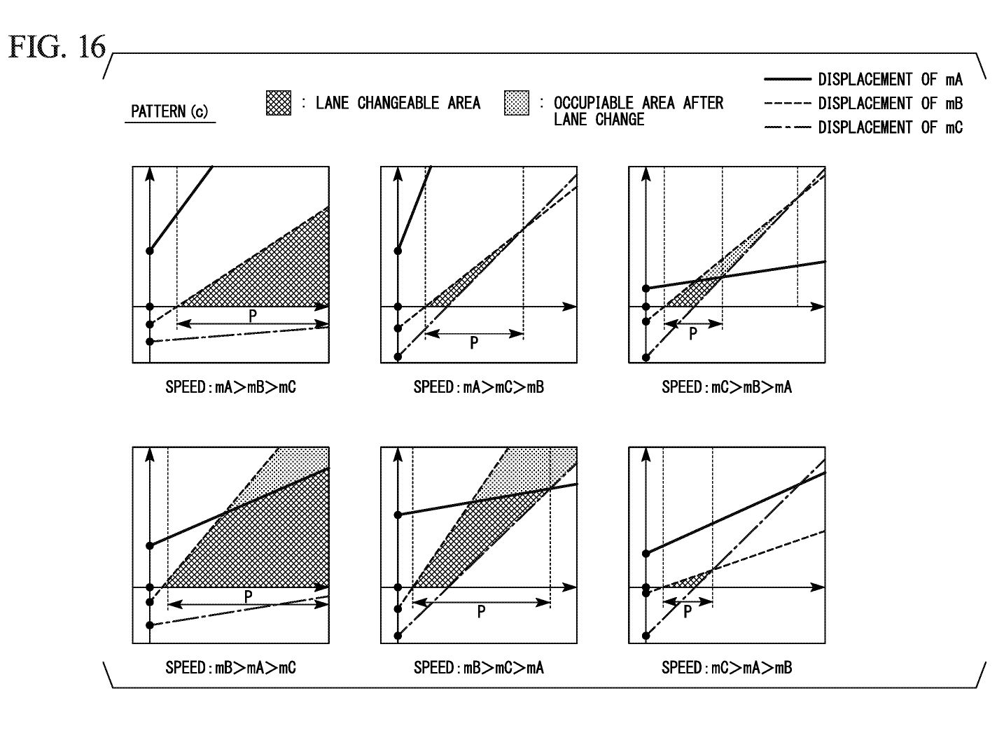

FIG. 16 is a diagram illustrating patterns obtained by categorizing a change in positions of the monitoring target vehicles in pattern (c). The lane changeable period P in pattern (c) is defined as follows.

Start point in time: A point in time when mB overtakes the subject vehicle M

End point in time: An earlier point in time between a point in time when mC catches up with mA and a point in time when mC catches up with mB

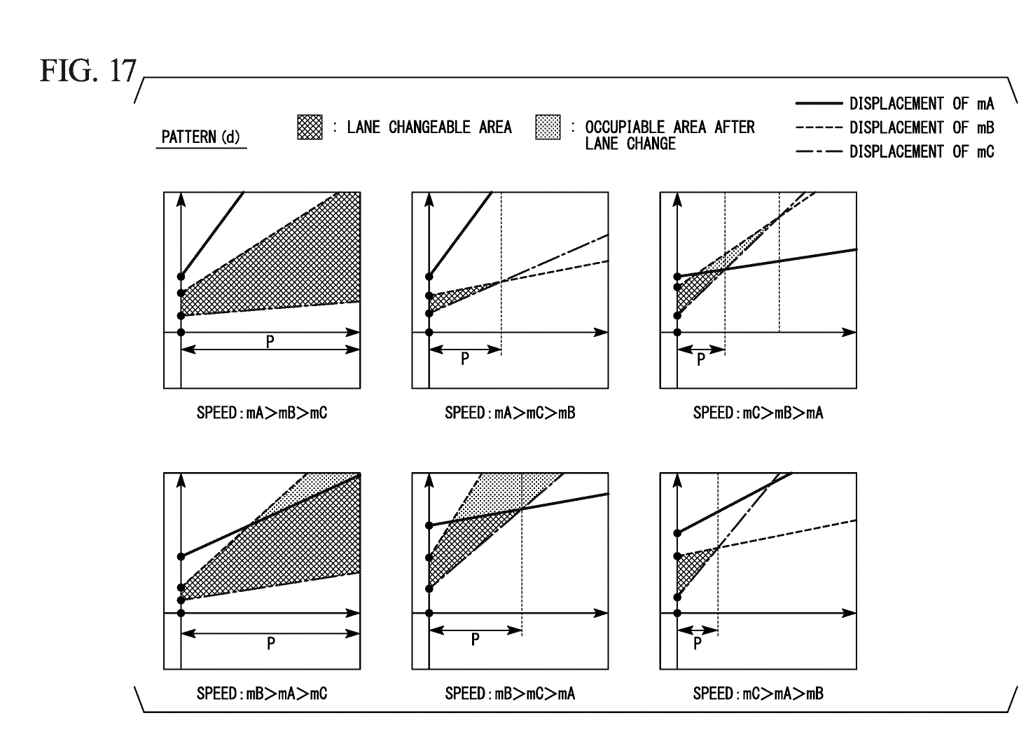

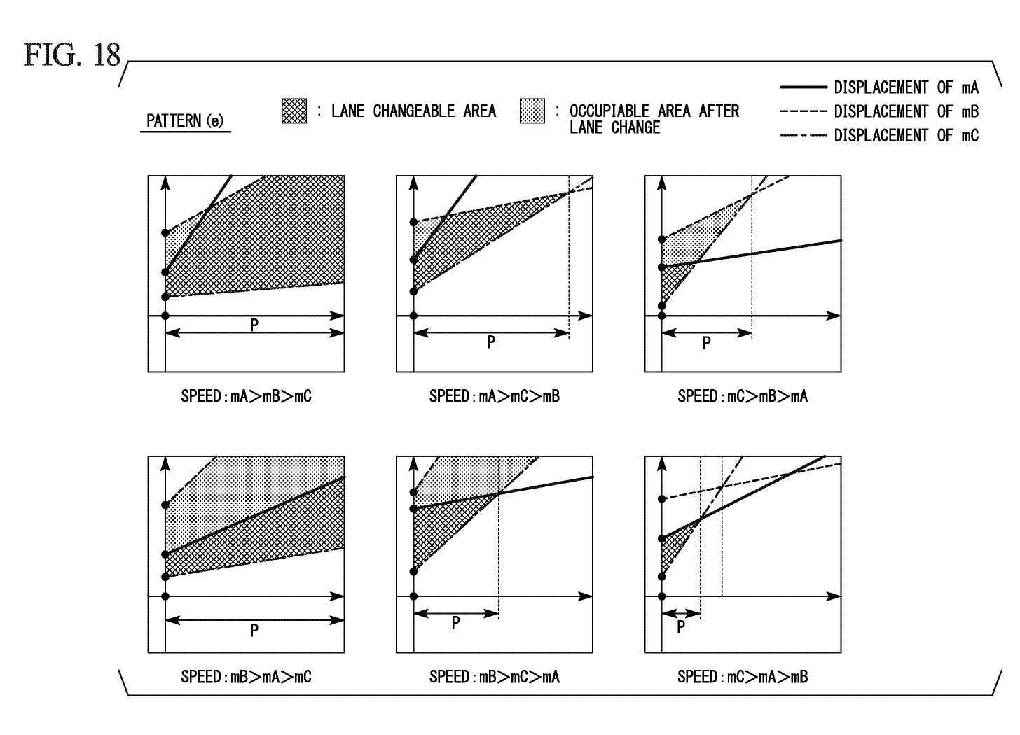

FIG. 17 is a diagram illustrating patterns obtained by categorizing a change in positions of the monitoring target vehicles in pattern (d). Further, FIG. 18 is a diagram illustrating patterns obtained by categorizing a change in positions of the monitoring target vehicles in pattern (e). The lane changeable period P in the patterns (d) and (e) is defined as follows (hereinafter “monitoring target vehicle” is omitted).

Start point in time: A point in time when the subject vehicle M overtakes mC

End point in time: An earlier point in time between a point in time when mC catches up with mA and a point in time when mC catches up with mB

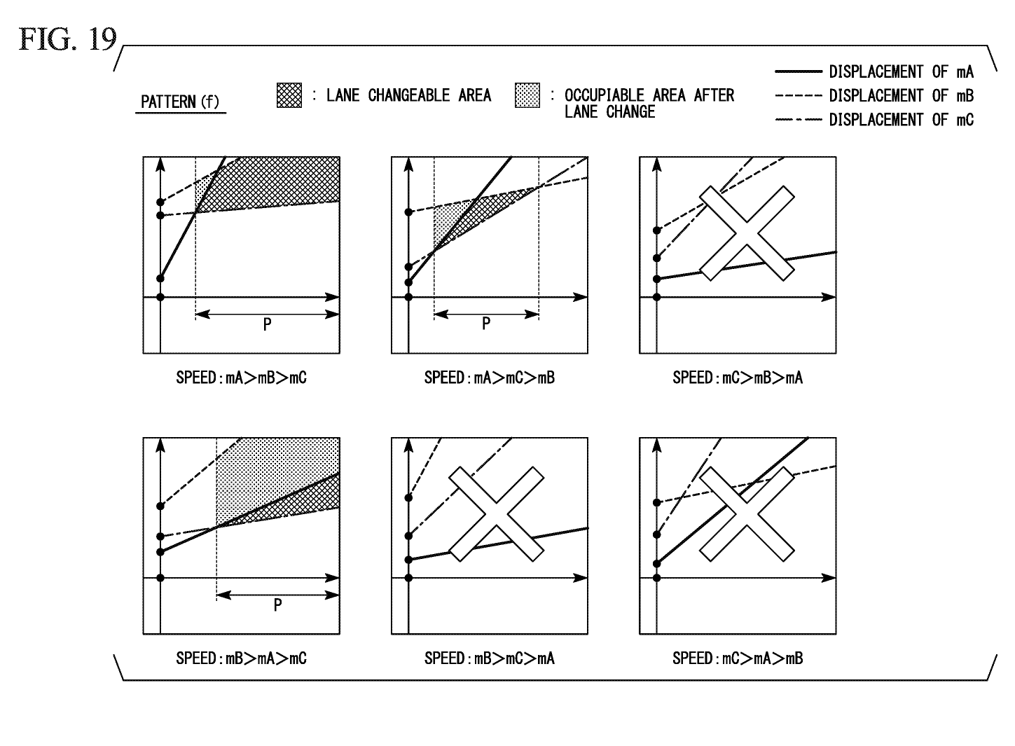

FIG. 19 is a diagram illustrating patterns obtained by categorizing a change in positions of the monitoring target vehicles in pattern (f). The lane changeable period P in pattern (f) is defined as follows.

Start point in time: A point in time when mA overtakes mC

End point in time: A point in time when mC catches up with mB (mC catching up with mA is not considered from restrictions of the start point in time)

In pattern (f), when the speed is mC>mB>mA, when mB>mC>mA, and when mC>mA>mB, lane change is impossible.

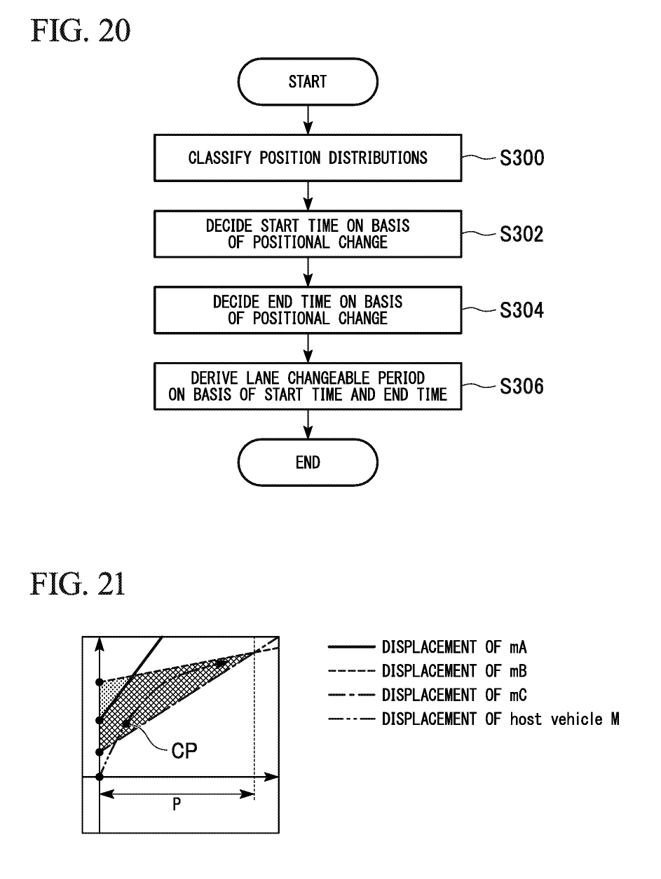

FIG. 20 is a flowchart illustrating an example of a flow of a process that is executed by the lane changeable period derivation unit 113. The process of this flowchart corresponds to the process of step S206 of FIG. 12.

First, the lane changeable period derivation unit 113 categorizes positional distributions between the subject vehicle M and the monitoring target vehicles mA, mB and mC (step S300). Then, the lane changeable period derivation unit 113 determines the start point in time of the lane changeable period on the basis of the change in positions of the monitoring target vehicles mA, mB, and mC estimated by the other-vehicle position change estimation unit 112 (step S302).

Here, in order to determine the start point in time of the lane change as described above, there are elements such as “a point in time at which the monitoring target vehicle mB overtakes the subject vehicle M” and “a point in time at which the subject vehicle M overtakes the monitoring target vehicle mC”, and in order to solve this, it is necessary to assume acceleration and deceleration of the subject vehicle M. In this regard, the lane changeable period derivation unit 113, for example, regards the subject vehicle M as decelerating by a predetermined degree (for example, about 20%) from the current speed of the subject vehicle M when the subject vehicle M decelerates, derives a speed change curve within a range in which sudden deceleration does not occur, and determines a “point in time when the monitoring target vehicle mB overtakes the subject vehicle M” together with a change in the position of the monitoring target vehicle mB. The lane changeable period derivation unit 113 derives a speed change curve having a statutory speed as an upper limit within a range in which sudden acceleration from the current speed of the subject vehicle M does not occur when the subject vehicle M accelerates, and determines a “point in time when the subject vehicle M overtakes the monitoring target vehicle mC” together with a change in the position of the monitoring target vehicle mC.

Then, the lane changeable period derivation unit 113 determines the end point in time of the lane changeable period on the basis of the change in positions of the monitoring target vehicles mA, mB, and mC estimated by the other-vehicle position change estimation unit 112 (step S304). The lane changeable period derivation unit 113 derives the lane changeable period on the basis of the start point in time determined in step S302 and the end point in time determined in step S304 (step S306).

Referring back to FIG. 12, the process of the flowchart will be described. The control plan generation unit 114 generates a control plan for the lane change target position candidate T for which the lane changeable period P has been derived (step S208). The lane change control unit 110 determines whether or not the processes of steps S200 to S208 have been performed on all the lane change target position candidates T (step S210). When the processes of steps S200 to S208 have not been performed on all the lane change target position candidates T, the process returns to step S200 to select the next lane change target position candidate T and perform the subsequent processes.

FIG. 21 is a diagram illustrating an example of a control plan for lane change generated by the control plan generation unit 114. For example, the control plan is represented by a trajectory of a displacement regarding the travel direction of the subject vehicle M. The control plan generation unit 114 first obtains a restriction on the speed of the subject vehicle M that can enter the lane changeable area. The restriction on the speed of the subject vehicle M includes the subject vehicle M being able to enter the lane changeable area within the lane changeable period P. Further, the restriction on the speed of the subject vehicle M may include following-traveling the monitoring target vehicle mB that is a preceding vehicle after the lane change. In this case, at a point in time at which this following traveling is started, the subject vehicle M may deviate from the lane changeable area and enter a presence possibility area after lane change.

Further, when the subject vehicle M needs to change lane after the subject vehicle M has overtaken the monitoring target vehicle mC, the control plan generation unit 114 generates a control plan so that the lane change is started at a point (CP in FIG. 21) at which the displacement of the subject vehicle M is sufficiently larger than the displacement of the monitoring target vehicle mC.

With such control, the lane change control unit 110 can realize smooth lane change control.

In a case in which the processes of steps S200 to S208 have been performed on all the lane change target position candidates T, the target position determination unit 115 determines the lane change target position T# by evaluating the corresponding control plan (step S212).

The target position determination unit 115, for example, determines the lane change target position T# from the viewpoint of safety or efficiency. The target position determination unit 115 refers to the control plan corresponding to each of the lane change target position candidates T to preferentially select a position at which an interval between front and rear vehicles at the time of the lane change is large, a position at which a speed is close to a statutory speed, or a position at which an acceleration or deceleration required at the time of the lane change is low, as the lane change target position T#. Thus, one lane change target position T# and the control plan are determined.

The lane change control unit 110 generates a trajectory for changing lane on the basis of the determined lane change target position T# and the control plan. The trajectory is a set (locus) of points obtained by sampling future target positions assumed to be reached at predetermined time intervals. Details will be described below.

### Travel Control

The travel control unit 120 sets a control mode an automatic driving mode or a manual driving mode under the control of the control switching unit 122, and controls a control target according to the set control mode. In the automatic driving mode, the travel control unit 120 reads action plan information 136 generated by the action plan generation unit 106, and controls the control target on the basis of an event included in the read action plan information 136. When this event is a lane change event, the travel control unit 120 determines the amount of control (for example, a rotation speed) of the electric motor in the steering device 92 and the amount of control (for example, a degree of throttle opening of an engine or a shift stage) of the ECU in the travel driving force output device 90 according to the control plan generated by the control plan generation unit 114. The travel control unit 120 outputs information indicating the amount of control determined for each event to the corresponding control target. Accordingly, each device (90, 92, 94) that is a control target can control the subject device according to the information indicating the amount of control input from the travel control unit 120. Further, the travel control unit 120 appropriately adjusts the determined amount of control on the basis of a detection result of the vehicle sensor 60.

Further, in the manual driving mode, the travel control unit 120 controls the control target on the basis of an operation detection signal output by the operation detection sensor 72. For example, the travel control unit 120 may output the operation detection signal output by the operation detection sensor to each device that is the control target as it is.

The control switching unit 122 switches the control mode of the subject vehicle M in the travel control unit 120 from the automatic driving mode to the manual driving mode or from the manual driving mode to the automatic driving mode on the basis of the action plan information 136 generated by the action plan generation unit 106. Further, the control switching unit 122 switches the control mode of the subject vehicle M in the travel control unit 120 from the automatic driving mode to the manual driving mode or from the manual driving mode to the automatic driving mode on the basis of the control mode designation signal input from the changeover switch 80. That is, the control mode of the travel control unit 120 can be arbitrarily changed during traveling or stopping by an operation of a driver or the like.

Further, the control switching unit 122 switches the control mode of the subject vehicle M in the travel control unit 120 from the automatic driving mode to the manual driving mode on the basis of an operation detection signal input from the operation detection sensor 72. For example, when the amount of an operation included in the operation detection signal exceeds a threshold value, that is, when the operation device 70 receives an operation with an amount of an operation exceeding the threshold value, the control switching unit 122 switches the control mode of the travel control unit 120 from automatic driving mode to the manual driving mode. For example, when the subject vehicle M is automatically traveling due to the travel control unit 120 being set to the automatic driving mode, and when a steering wheel, an accelerator pedal, or a brake pedal is operated with an amount of an operation exceeding the threshold value by the driver, the control switching unit 122 switches the control mode of the travel control unit 120 from the automatic driving mode to the manual driving mode. Accordingly, the vehicle control device 100 can perform switching to the manual driving mode immediately without an operation of the changeover switch 80, through an operation immediately performed by the driver when an object such as a person jumps into a road or a preceding vehicle suddenly stops. As a result, the vehicle control device 100 can respond to an operation of the driver at the time of emergency, thereby improving the safety during traveling.

According to the vehicle control device 100 of this embodiment described above, the target position candidate setting unit 111 can prevent the lane change target position candidate T from being set to a position considered difficult to change lanes, such as in front of a nearby vehicle traveling in front of the preceding vehicle or behind a nearby vehicle traveling behind the following vehicle. As a result, the target position candidate setting unit 111 can prevent the subject vehicle M from being forced into an unreasonable behavior at the time of the lane change.

Further, according to the vehicle control device 100 of this embodiment, the target position candidate setting unit 111 sets a plurality of candidates of lane change destinations according to a distribution of the nearby vehicles, such that a degree of freedom of the lane change control can be increased. As a result, it is possible to set an optimal lane change target position later.

Further, according to the vehicle control device 100 of this embodiment, the lane changeable period derivation unit 113 can assist in various processes such as generation of the control plan for lane change by deriving the lane changeable period P in which the lane can be changed to the lane change target position candidate T set as a relative position with respect to the nearby vehicle traveling in the adjacent lane L2 adjacent to the subject lane L1 on the basis of the change in the position of the nearby vehicle (monitoring target vehicle).

Further, according to the vehicle control device 100 of this embodiment, the control plan generation unit 114 derives a restriction on the speed for changing lane to the lane change target position T# within the lane changeable period P derived by the lane changeable period derivation unit 113 and generates the control plan under the derived restrictions on the speed, thereby preventing occurrence of a situation in which an unrealizable control plan can be established.

Further, according to the vehicle control device 100 of this embodiment, the lane changeable period derivation unit 113 derives the lane changeable period P using a different scheme according to the position distribution between the subject vehicle M and the monitoring target vehicles, thereby deriving the lane changeable period P using an appropriate scheme according to the position distribution between the subject vehicle M and the monitoring target vehicles.

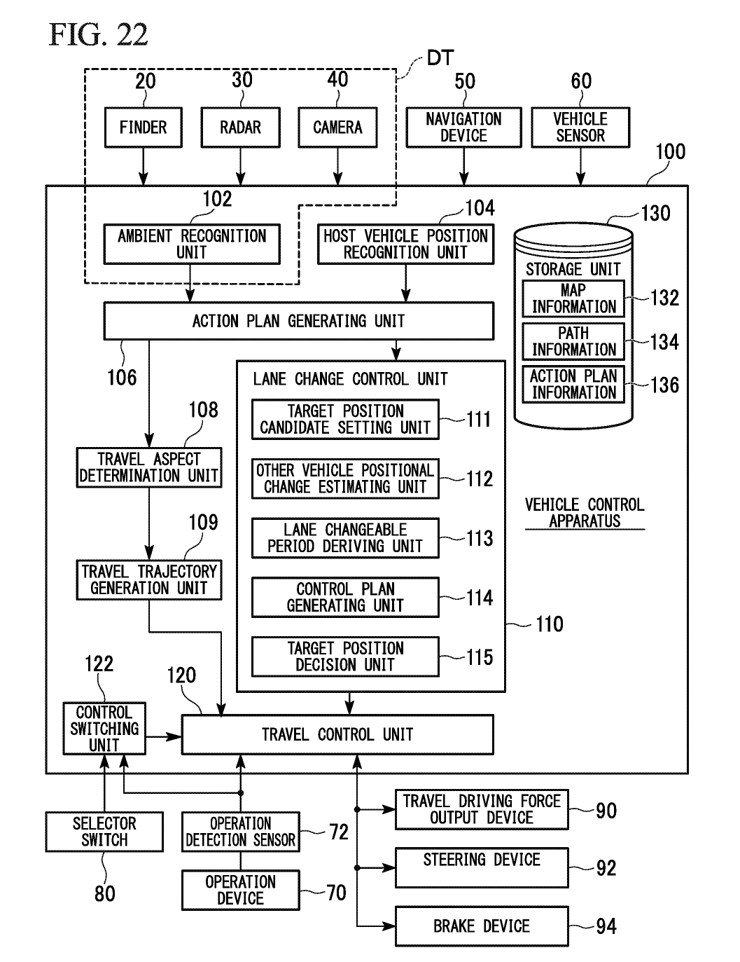

The vehicle control device 100 may further include a travel aspect determination unit 108 and a travel trajectory generation unit 109 in addition to the above-described functional units. FIG. 22 is a diagram illustrating a functional configuration of the vehicle control device 100 including the travel aspect determination unit 108 and the travel trajectory generation unit 109.

### Lane Keeping Event

When a lane keeping event included in the action plan is executed by the travel control unit 120, the travel aspect determination unit 108 determines a traveling aspect of any one of constant speed traveling, following traveling, decelerating traveling, curved traveling, obstacle avoidance traveling, and the like. For example, when there are no other vehicles in front of the subject vehicle M, the travel aspect determination unit 108 may determine the travel aspect to be constant speed traveling. Further, when the vehicle follows the preceding vehicle, the travel aspect determination unit 108 may determine the travel aspect to be following traveling. Further, when the outside world recognition unit 102 recognizes deceleration of the preceding vehicle or when an event such as stopping or parking is performed, the travel aspect determination unit 108 may determine the travel aspect to be decelerating traveling. Further, when the outside world recognition unit 102 recognizes that the subject vehicle M has arrived at a curved road, the travel aspect determination unit 108 may determine the travel aspect to be curved traveling. Further, when an obstacle is recognized in front of the subject vehicle M by the outside world recognition unit 102, the travel aspect determination unit 108 may determine the travel aspect to be the obstacle avoidance traveling.

The travel trajectory generation unit 109 generates a trajectory on the basis of the travel aspect determined by the travel aspect determination unit 108. The trajectory is a set (locus) of points obtained by sampling future target positions assumed to be reached at predetermined time intervals when the subject vehicle M travels on the basis of the travel aspect determined by the travel aspect determination unit 108. The travel trajectory generation unit 109 calculates the target speed of the subject vehicle M on the basis of at least the speed of a target OB present in front of the subject vehicle M recognized by the outside world recognition unit 102 or the subject-vehicle position recognition unit 104, and the distance between the subject vehicle O and the target OB. The travel trajectory generation unit 109 generates a trajectory on the basis of the calculated target speed. The target OB includes a preceding vehicle, a point such as a merging point, a branch point, or a target point, an object such as an obstacle, and the like.

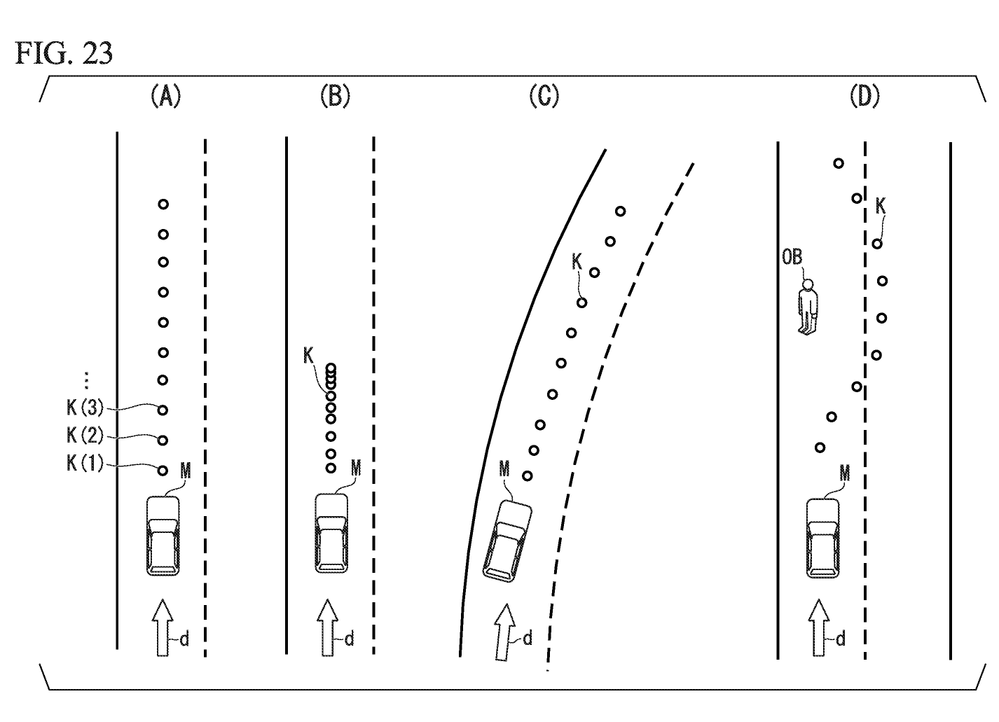

Hereinafter, the generation of the trajectory, particularly, in both a case in which the presence of the target OB is not considered and a case in which the presence of the target OB is considered will be described. FIG. 23 is a diagram illustrating an example of a trajectory generated by the travel trajectory generation unit 109. As illustrated in (A) of FIG. 23, for example, the travel trajectory generation unit 109 sets future target positions K(1), K(2), K(3), . . . as the trajectory of the subject vehicle M each time a predetermined time Δt elapses from a current time on the basis of the current position of the subject vehicle M. Hereinafter, these target positions are simply referred to as a “target position K” when not distinguished. For example, the number of target positions K is determined according to a target time T. For example, when the target time T is set to five seconds, the travel trajectory generation unit 109 sets the target positions K on a center line of the travel lane in increments of a predetermined time Δt (for example, 0.1 second) during five seconds, and determines an arrangement interval of the plurality of target positions K on the basis of a travel aspect. For example, the travel trajectory generation unit 109 may derive the center line of the driving lane from information such as a width of the lane included in the map information 132 or may acquire the center line from the map information 132 when the center line is included in the map information 132 in advance.

For example, when the travel aspect is determined to be constant speed traveling by the travel aspect determination unit 108 described above, the travel trajectory generation unit 109 may set a plurality of target positions K at equal intervals to generate a trajectory as illustrated in (A) of FIG. 23.

Further, when the travel aspect is determined to be deceleration traveling by the travel aspect determination unit 108 (including a case in which a preceding vehicle decelerates in the follow-up traveling), the travel trajectory generation unit 109 may generate a trajectory in which an interval is wider between the target positions K at which an arrival time is earlier and is narrower between the target positions K at which the arrival time is later, as illustrated in (B) of FIG. 23. In this case, the preceding vehicle may be set as the target OB or a point such as a merging point, a branch point, a target point, an obstacle, or the like other than the preceding vehicle may be set as the target OB. Accordingly, since the target position K at which the arrival time of the subject vehicle M is later becomes closer to the current position of the subject vehicle M, the travel control unit 120 which will be described below decelerates the subject vehicle M.

Further, as illustrated in (C) of FIG. 23, when the road is a curved road, the travel aspect determination unit 108 may determine the travel aspect to be curved traveling. In this case, the travel trajectory generation unit 109, for example, arranges a plurality of target positions K while changing a lateral position (a position in a lane width direction) with respect to the travel direction of the subject vehicle M according to a curvature of the road, to generate a trajectory. Further, as illustrated in (D) of FIG. 23, when there is an obstacle OB such as a person or a stopped vehicle on a road in front of the subject vehicle M, the travel aspect determination unit 108 sets the travel aspect to obstacle avoidance traveling. In this case, the travel trajectory generation unit 109 arranges a plurality of target positions K so that the vehicle travels while avoiding the obstacle OB, to generate a trajectory.

### Second Embodiment

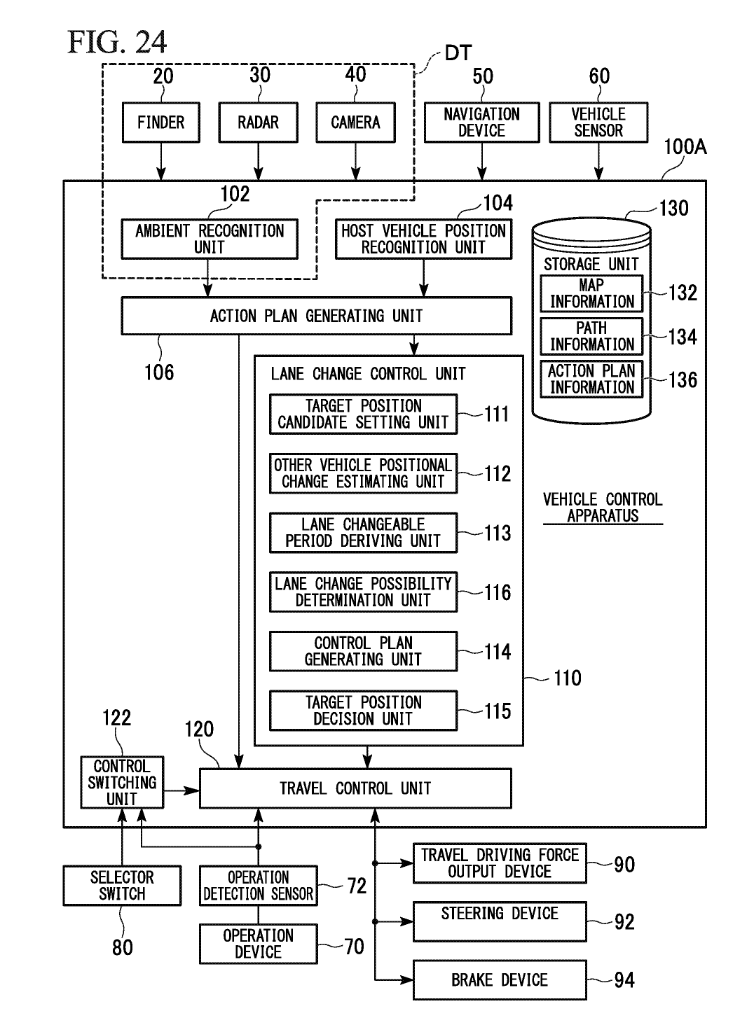

A second embodiment will be described below. FIG. 24 is a functional configuration diagram of the subject vehicle M including a vehicle control device 100A according to the second embodiment. The vehicle control device 100A according to the second embodiment is different from that according to the first embodiment in that the lane change control unit 110 includes a lane change possibility determination unit 116. The differences will be mainly described below

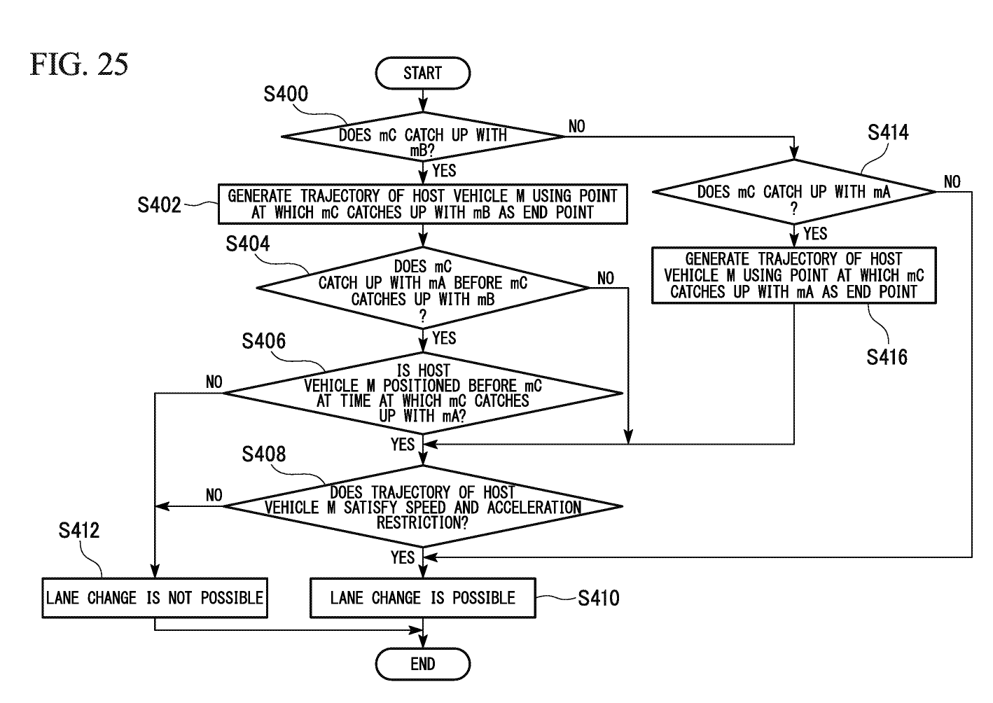

FIG. 25 is a flowchart illustrating an example of a flow of a process that is executed by the lane change possibility determination unit 116 according to the second embodiment. First, the lane change possibility determination unit 116 determines whether or not the monitoring target vehicle mC will catch up with mB (step S400).

When the monitoring target vehicle mC catches up with mB, the lane change possibility determination unit 116 generates a locus of a displacement of the subject vehicle M using a point at which the monitoring target vehicle mC catches up with mB as an end point (step S402). Then, the lane change possibility determination unit 116 determines whether or not the monitoring target vehicle mC will catch up with mA before the monitoring target vehicle mC catches up with mB (step S404).

When the monitoring target vehicle mC catches up with mA before the monitoring target vehicle mC catches up with mB (see an upper right diagram of FIG. 14 or the like), the lane change possibility determination unit 116 determines whether or not the subject vehicle M will be in front of the monitoring target vehicle mC at a point in time at which the monitoring target vehicle mC catches up with mA (step S406).

When the subject vehicle M is in front of the monitoring target vehicle mC at a time in time at which the monitoring target vehicle mC catches up with the mA, the lane change possibility determination unit 116 determines whether or not the locus of the subject vehicle M satisfies the restrictions of speed and acceleration (step S408). The restrictions on the speed and the acceleration are defined as, for example, the speed being within a range of speed in which a statutory speed is an upper limit and about 60% of the statutory speed is a lower limit, and an acceleration and a deceleration being lower than respective set threshold values.

When the locus of the subject vehicle M satisfies the restrictions of speed and acceleration, the lane change possibility determination unit 116 determines that lane change is possible (step S410). On the other hand, when the locus of the subject vehicle M does not satisfy the restrictions of speed and acceleration, the lane change possibility determination unit 116 determines that the lane change is impossible (step S412).

When a negative determination is obtained in step S400, the lane change possibility determination unit 116 determines whether or not the monitoring target vehicle mC will catch up with mA (step S414). When the monitoring target vehicle mC catches up with mA (see a lower middle diagram or the like in FIG. 14), the lane change possibility determination unit 116 generates the locus of the subject vehicle M using the point in time at which the monitoring target vehicle mC catches up with the mA as an end point (S416), and the process proceeds to step S408.

On the other hand, when the monitoring target vehicle mC does not catch up with mA (see an upper left drawing or the like in FIG. 14), the lane change possibility determination unit 116 determines that lane change is possible (step S410).

According to the vehicle control device 100A of this embodiment described above, it is possible to achieve the same effects as those of the first embodiment, and to more appropriately determine whether or not lane change is possible by determining whether or not the nearby vehicle traveling immediately after the lane change target position T# set as a relative position with respect to the nearby vehicle traveling in the adjacent lane L2 adjacent to the subject lane L1 will catch up with another nearby vehicle, and determining whether or not the lane change is possible on the basis of a result of the determination.

### Third Embodiment

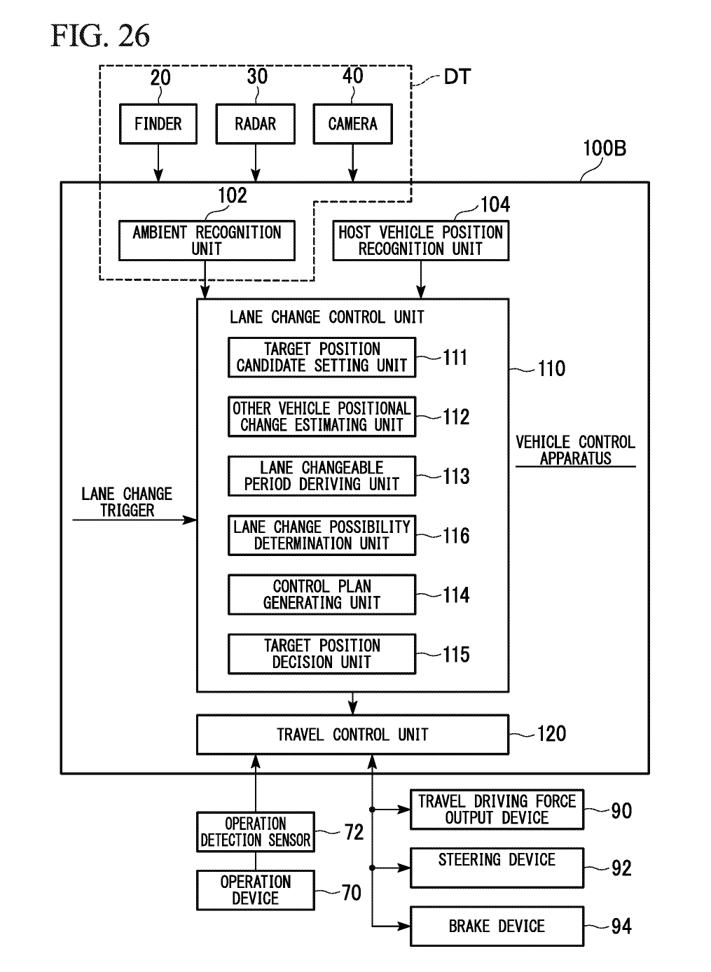

Hereinafter, a third embodiment will be described. FIG. 26 is a functional configuration diagram of the subject vehicle M including a vehicle control device 100B according to the third embodiment. The vehicle control device 100B according to the third embodiment does not have a configuration for generating an action plan in cooperation with the navigation device 50. The vehicle control device 100B performs lane change control when an arbitrary lane change trigger is input, and performs control in a manual driving mode in other cases. The subject-vehicle position recognition unit 104 refers to a GNSS receiver, map information, or the like (which does not necessarily belong to the navigation device) to recognize a subject-vehicle position.

The lane change trigger is generated, for example, when a switch operation or the like for lane change is performed by the driver. Further, the lane change trigger nay be automatically generated according to a state of the vehicle.

### Fourth Embodiment

A fourth embodiment will be described below. The vehicle control device 100 according to the first embodiment sets a lane change target position candidate without considering nearby vehicles traveling in a lane adjacent to a lane in which the subject vehicle M is about to change lane. On the other hand, the vehicle control device 100C of the fourth embodiment sets the lane change target position candidate in consideration of the nearby vehicles traveling in the lane adjacent to the lane in which the subject vehicle M is about to change lane, which is different from in the first embodiment. The difference will be mainly described below.

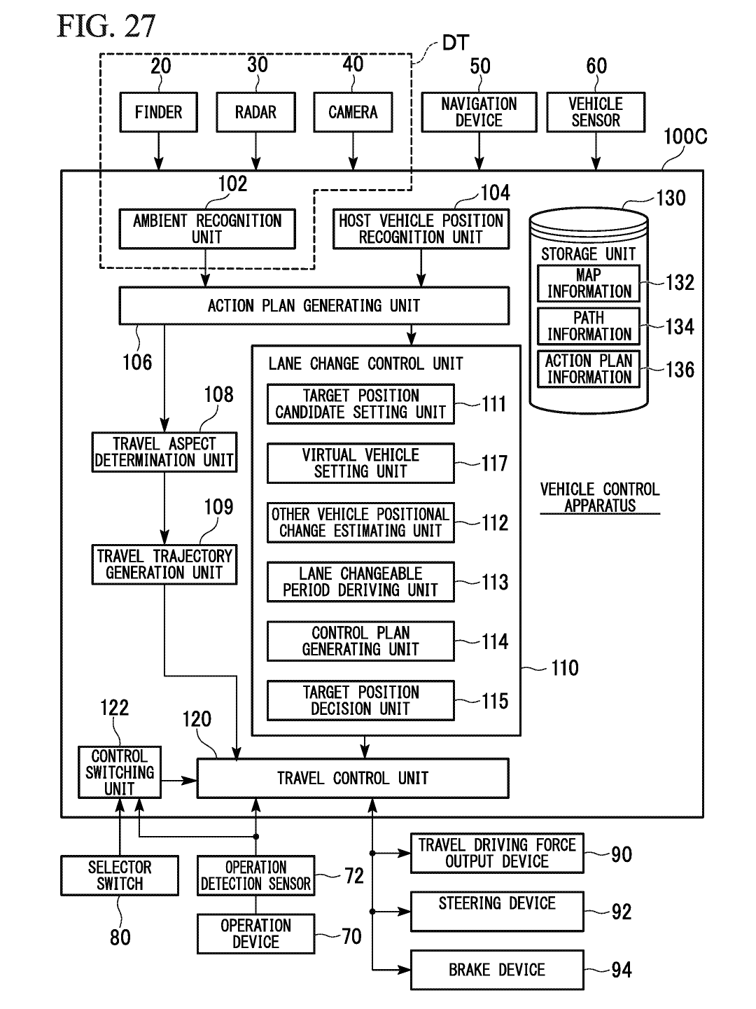

FIG. 27 is a functional configuration diagram of the subject vehicle M including the vehicle control device 100C according to the fourth embodiment. The vehicle control device 100C of the fourth embodiment further includes a virtual vehicle setting unit 117 in addition to the functional configuration of the vehicle control device 100C of the first embodiment.

As in the first embodiment, an outside world recognition unit 102 of the vehicle control device 100C estimates whether or not a nearby vehicle is changing lane (whether or not a nearby vehicle is about to change lane) on the basis of a history of a position of the nearby vehicle, an operation state of a direction indicator, or the like. The outside world recognition unit 102 is an example of an “estimation unit”.

The virtual vehicle setting unit 117 sets a virtual vehicle obtained by virtually simulating a nearby vehicle in a predetermined state when there is a nearby vehicle determined to change a lane to a lane that is a lane change destination of the subject vehicle M by the outside world recognition unit 102. The predetermined state is, for example, a state in which a speed of the nearby vehicle at the present point in time is maintained. The predetermined state may be a speed lower or higher than the speed of the nearby vehicle at the present point in time.

The target position candidate setting unit 111 refers to the position of the nearby vehicle detected by the detection unit DT, regards the virtual vehicle set by the virtual vehicle setting unit 117 as the nearby vehicle, and sets the lane change target position candidate.

### Example in Which There is Nearby Vehicle in Lane That is Lane Change Destination

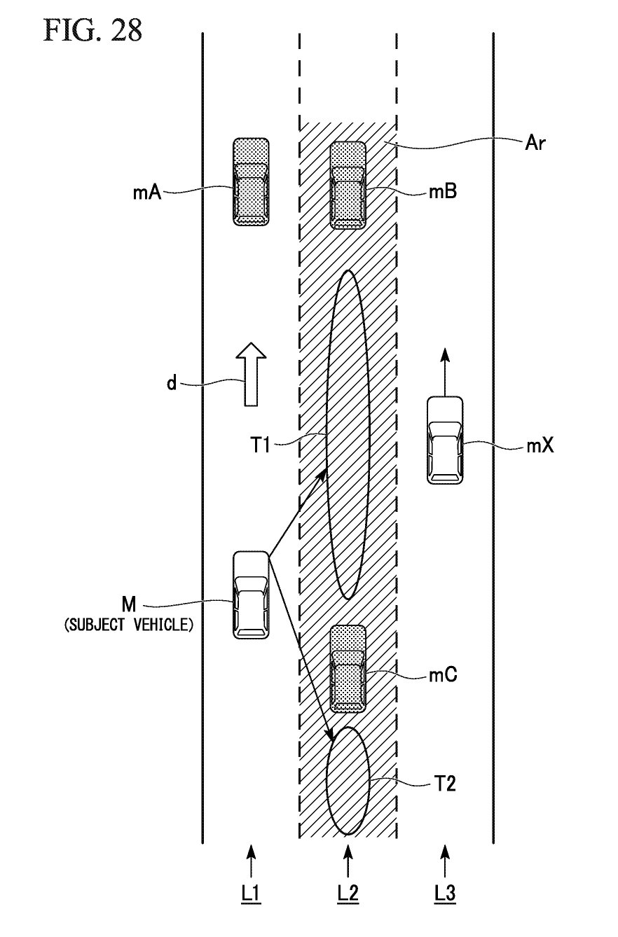

FIG. 28 is a diagram illustrating a state in which the target position candidate setting unit 111 according to the fourth embodiment sets lane change target position candidates. In FIG. 28, L1 is a subject lane, L2 is an adjacent lane (a lane that is a lane change destination of the subject vehicle M), and L3 is a lane adjacent to the adjacent lane (hereinafter, a third lane). T1 and T2 are lane change target position candidates. In FIG. 28, mA to mX are nearby vehicles. The nearby vehicle mA is a preceding vehicle, the nearby vehicle mB is a vehicle traveling immediately in front of the subject vehicle M in the adjacent lane L2, and the nearby vehicle mC is a vehicle traveling immediately behind the subject vehicle M in the adjacent lane L2. The nearby vehicle mX is located between the nearby vehicle mB and the nearby vehicle mC in the third lane L3 and travels at such a position.

First, in the fourth embodiment, the target position candidate setting unit 111 sets an area including the nearby vehicle mB and the nearby vehicle mC traveling in the adjacent lane L2 as the target area Ar. A scheme of setting the target area Ar may be the same as in the first embodiment. The target position candidate setting unit 111 sets the lane change target position candidates T1 and T2 at positions at which the subject vehicle M can safely change lane without interfering with, for example, the nearby vehicle mB and the nearby vehicle mC. The target position candidate setting unit 111 sets the lane change target position candidate T1, for example, between the nearby vehicles mB and mC. The target position candidate setting unit 111 sets the lane change target position candidate T2 behind the nearby vehicle mC, for example. When there is no area in which the subject vehicle M may perform the lane change behind the nearby vehicle mC, the target position candidate setting unit 111 does not set the lane change target position candidate T2 and sets only the lane change target position candidate T1.

Therefore, the number of lane change target position candidates T is changed according to the number of nearby vehicles traveling in the target area Ar in the adjacent lane L2. Further, a size of the area in which the lane change target position candidate T is formed varies according to a size of an area between nearby vehicles traveling in the target area Ar in the adjacent lane L2.

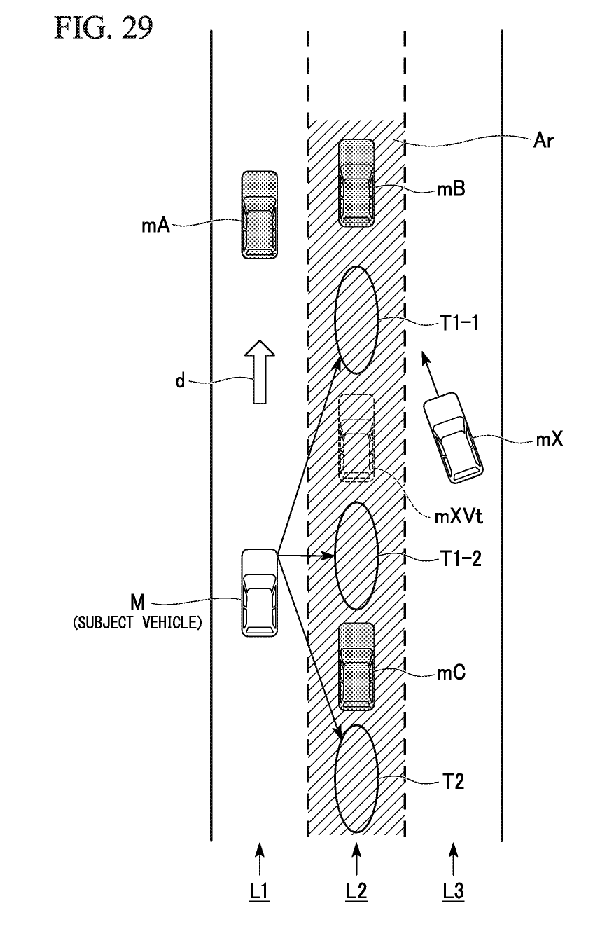

When the virtual vehicle is set by the virtual vehicle setting unit 117, the target position candidate setting unit 111 regards the virtual vehicle as a nearby vehicle and sets the lane change target position candidate T in the target area Ar. FIG. 29 is a diagram illustrating a state in which the target position candidate setting unit 111 sets the lane change target position candidate T when the virtual vehicle is set. In the example illustrated in FIG. 29, since a direction indicator of the nearby vehicle mX is operating to show that the nearby vehicle mX is changing lane to the adjacent lane L2, the outside world recognition unit 102 is assumed to have estimated the lane change to the adjacent lane L2 of the nearby vehicle mX. When the outside world recognition unit 102 has estimated the lane change of the nearby vehicle, the virtual vehicle setting unit 117 sets a virtual vehicle mXVt corresponding to the nearby vehicle mX on the adjacent lane L2. The virtual vehicle setting unit 117, for example, sets the virtual vehicle mXVt in a state in which the speed of the nearby vehicle at the present time is maintained in a lateral direction of the nearby vehicle mX.

The target position candidate setting unit 111 regards the set virtual vehicle mXVt as the nearby vehicle that is located between the nearby vehicles mB and mC in the adjacent lane L2 and travels at such a position. The target position candidate setting unit 111 sets the lane change target position candidate T in the target area Ar on the basis of the nearby vehicles mB and mC and the virtual vehicle mXVt. In this case, for example, the target position candidate setting unit 111 sets the lane change target position candidates T (T1−1, T1−2, and T2) at a position between the nearby vehicles mB and mC, a position between the nearby vehicle mC and the virtual vehicle mXVt, and a position behind the nearby vehicle mC. However, when there is not a sufficient area for lane change of the subject vehicle M at the position between the nearby vehicle mB and the virtual vehicle mXVt or the position between the nearby vehicle mC and the virtual vehicle mXVt, the target position candidate setting unit 111 excludes the position from the lane change target position candidates T.

Thus, when there is a nearby vehicle estimated to change a lane to the lane that is the lane change destination of the subject vehicle M, the vehicle control device 100 sets the virtual vehicle obtained by virtually simulating the nearby vehicle in the lane that is the lane change destination, and sets the lane change target position candidate on the basis of nearby vehicles traveling in the lane that is the lane change destination and the virtual vehicle. As a result, the vehicle control device 100 can increase a degree of freedom of the lane change control while preventing the candidate for the lane change target position from being set at a position considered to be difficult to change lane.

### Example in Which There is no Nearby Vehicle in Lane That is Lane Change Destination

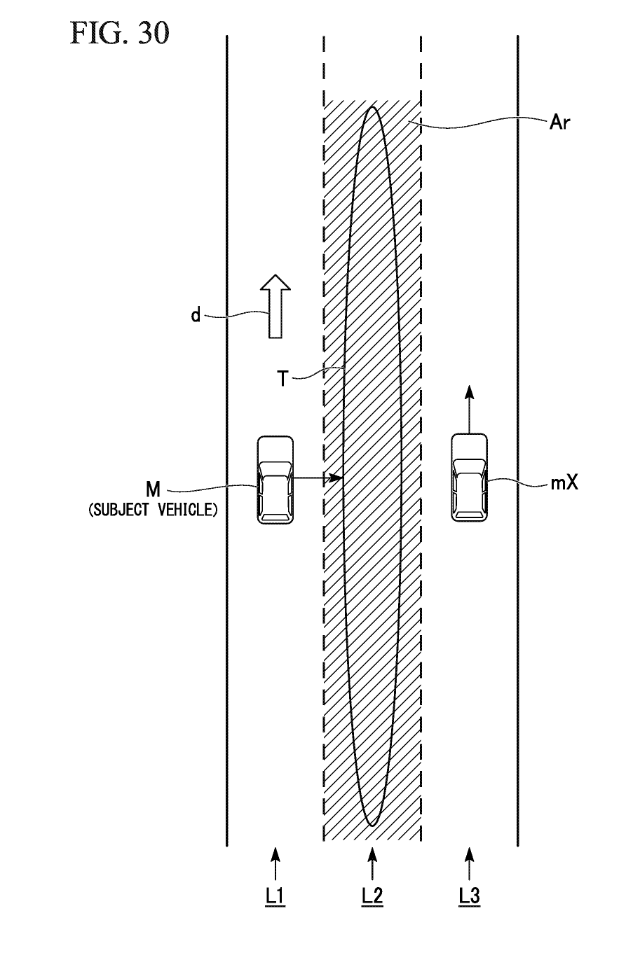

Further, even when a nearby vehicle is not traveling in the adjacent lane L2, the vehicle control device 100 may set a virtual vehicle in the adjacent lane L2 when a nearby vehicle traveling in the third lane L3 is estimated to change lane to the adjacent lane L2. FIG. 30 is a diagram illustrating a state in which the target position candidate setting unit 111 sets the lane change target position candidate T when a nearby vehicle is not traveling in the adjacent lane L2. When a nearby vehicle is not traveling in the adjacent lane L2, for example, the target position candidate setting unit 111 sets a desired area in the target area Ar as the lane change target position candidate T. The desired area may be the entire target area Ar or may be part thereof.

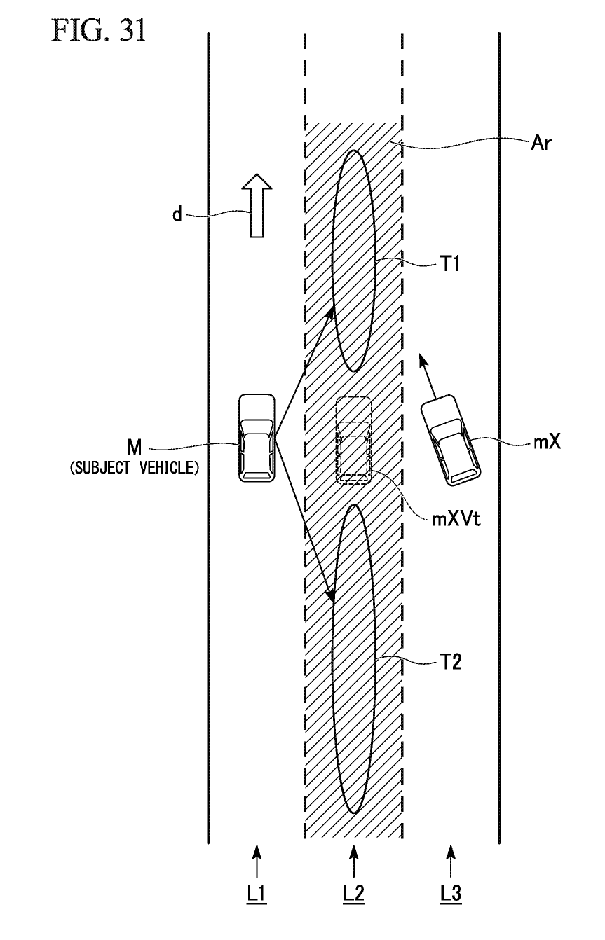

When the virtual vehicle is set by the virtual vehicle setting unit 117, the target position candidate setting unit 111 regards the virtual vehicle as a nearby vehicle and sets the lane change target position candidate T in the target area Ar. FIG. 31 is a diagram illustrating a state in which the target position candidate setting unit 111 sets lane change target position candidates TI and T2 when a virtual vehicle is set. When the outside world recognition unit 102 estimates lane change of the nearby vehicle, the virtual vehicle setting unit 117 sets a virtual vehicle mXVt corresponding to the nearby vehicle mX on the adjacent lane L2.

The target position candidate setting unit 111 regards the set virtual vehicle mXVt as a nearby vehicle in the adjacent lane L2. For example, the target position candidate setting unit 111 sets lane change target position candidates T (T1 and T2) in front of and behind the virtual vehicle mXVt.

Thus, when the nearby vehicle traveling in the third lane is estimated to be about to change the lane to the lane that is a lane change destination, the vehicle control device 100 sets the virtual vehicle in the lane that is a lane change destination and regards the virtual vehicle as the nearby vehicle traveling in the lane that is a lane change destination, thereby preventing the lane change target position candidate from being set at the position considered to be difficult to change lane.

### Example in Which Vehicle Traveling in Subject Lane Changes Lane to Lane That is Lane Change Destination

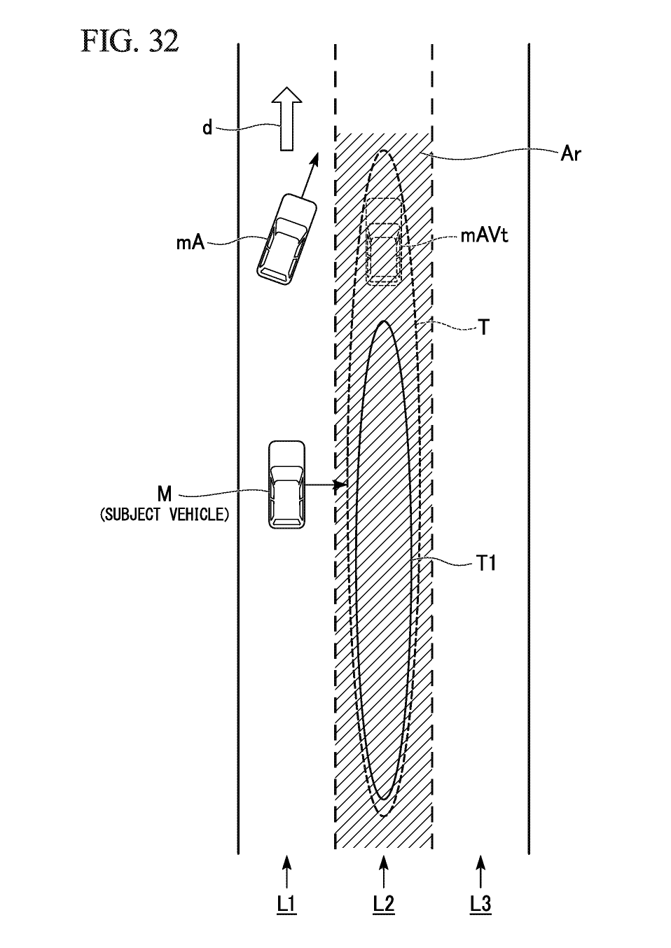

The vehicle control device 100 may set the virtual vehicle in the adjacent lane L2 when the nearby vehicle traveling in the subject lane L1 is estimated to be about to change the lane to the adjacent lane L2. When the virtual vehicle is set, the target position candidate setting unit 111 regards the virtual vehicle as a nearby vehicle and sets the lane change target position candidate T in the target area Ar. FIG. 32 is a diagram illustrating a state in which the target position candidate setting unit 111 sets the lane change target position candidate T1 when the virtual vehicle is set. When the outside world recognition unit 102 estimates that the nearby vehicle mA traveling in the subject lane L1 changes lane to the adjacent lane L2, the virtual vehicle setting unit 117 sets the virtual vehicle mAVt corresponding to the nearby vehicle mA on the adjacent lane L2.

The target position candidate setting unit 111 regards the set virtual vehicle mAVt as a nearby vehicle in the adjacent lane L2. For example, the target position candidate setting unit 111 may set the lane change target position candidate T1 obtained by changing the lane change target position candidate T such that it does not interfere with the virtual vehicle mAVt, behind the virtual vehicle mAVt.

Thus, in the vehicle control device 100, even when the nearby vehicle traveling in the subject lane L1 is estimated to change the lane to the adjacent lane L2, the target position candidate setting unit 111 sets the virtual vehicle in the lane that is the lane change destination, regards the set virtual vehicle as the nearby vehicle, and sets the lane change target position candidate T in the target area Ar, thereby preventing the lane change target position candidate from being set at a position considered to be difficult to change lane.

### Example in Which the Third Lane Disappears

Although the outside world recognition unit 102 estimates whether or not the nearby vehicle is changing lane (whether or not the nearby vehicle is about to change lane) on the basis of the operation state of the direction indicator or the like in the example described above, the outside world recognition unit 102 may estimate the lane change of the nearby vehicle on the basis of a distance to a lane decrease position or an arrival time when the lane decrease in front of the subject vehicle M is detected on the basis of the position of the subject vehicle acquired from the navigation device 50 and the map information 132 or the information input from the finder 20, the radar 30, the camera 40, or the like.

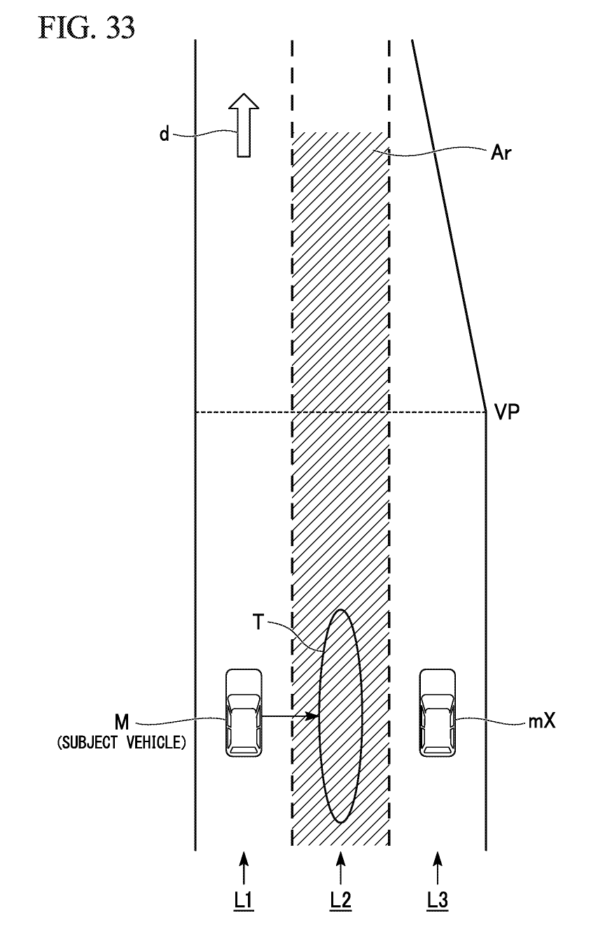

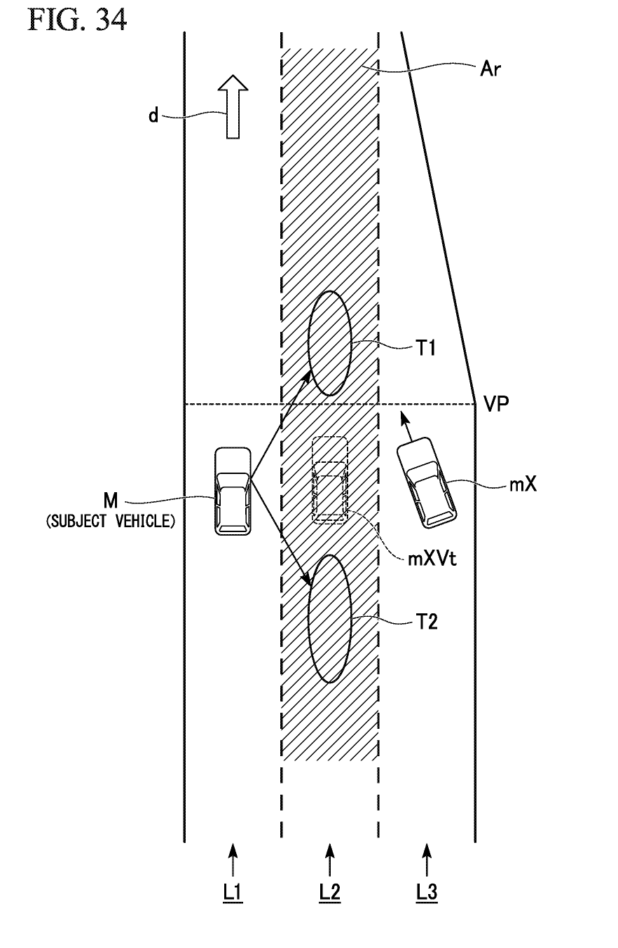

The outside world recognition unit 102 searches for the map information 132 on the basis of the position of the subject vehicle M acquired from the navigation device 50, and determines whether or not there is a point VP (see FIG. 33 to be described below) at which the lane narrows within a first predetermined distance (for example, hundreds of meters to several kilometers) forward from the position of the subject vehicle M. When the outside world recognition unit 102 determines whether or not there is the point VP at which the lane narrows, the outside world recognition unit 102 outputs an estimation result indicating that the nearby vehicle changes lane to another functional unit (the lane changing control unit 110 or the like) in a subsequent stage at a timing when a distance from the subject vehicle M or a nearby vehicle traveling in the disappearing lane to the point VP or an arrival time (obtained by dividing the distance by the speed of the subject vehicle M or the nearby vehicle) becomes less than a predetermined value. That is, a timing of the lane change is estimated on the basis of the distance from the subject vehicle M or the nearby vehicle traveling in the disappearing lane to the point VP or the arrival time. The predetermined value is set to, for example, about tens of meters when the value is a value for the distance, and is set to, for example, about several seconds when the value is a value for the arrival time.

Further, the outside world recognition unit 102 may detect a decrease in the lane in front of the subject vehicle M on the basis of the image obtained by imaging the front of the subject vehicle M using the camera 40.

FIG. 33 is a diagram illustrating a state in which the target position candidate setting unit 111 sets the lane change target position candidate T before the lane disappears. A third lane L3 is a lane that gradually decreases from the point VP and then disappears. In the example illustrated in FIG. 33, it is assumed that the arrival time at which the nearby vehicle mX traveling in the third lane L3 disappearing before the point VP arrives at the point VP is not within the predetermined value. In this case, the outside world recognition unit 102 estimates that the nearby vehicle X does not change the lane. The target position candidate setting unit 111 sets the lane change target position candidate T in the adjacent lane L2.

FIG. 34 is a diagram illustrating a state in which the target position candidate setting unit 111 sets the lane change target position candidate T when the arrival time at which the vehicle arrives at the point VP is within a predetermined value. When the arrival time at which the nearby vehicle mX arrives at the point VP is within a predetermined value, the outside world recognition unit 102 estimates that the nearby vehicle mX changes the lane. In this case, the virtual vehicle setting unit 117 sets the virtual vehicle mXVt corresponding to the nearby vehicle mX on the adjacent lane L2. The target position candidate setting unit 111 regards the virtual vehicle mXVt set by the virtual vehicle setting unit 117 as a nearby vehicle and sets the lane change target position candidates T (T1 and T2) in front of and behind the virtual vehicle mXVt. The target position candidate setting unit 111 may set the lane change target position candidate T in front of or behind the virtual vehicle mXVt.

The outside world recognition unit 102 may estimate the lane change of the nearby vehicle using the history of the position of the nearby vehicle, an operating state of the direction indicator, the position of the subject vehicle acquired from the navigation device 50, the map information 132, and the information input from the finder 20, the radar 30, the camera 40, or the like in parallel.

According to the fourth embodiment described above, the vehicle control device 100 sets the number of lane change target position candidates T varying according to the number of nearby vehicles traveling in the target area Ar in the adjacent lane, in the target area Ar. More specifically, when there is a nearby vehicle determined to change a lane to the lane that is the lane change destination of the subject vehicle M, the vehicle control device 100 sets the virtual vehicle obtained by virtually simulating the nearby vehicle in the adjacent lane, and sets the lane change target position candidate on the basis of the nearby vehicles traveling in the adjacent lane and the virtual vehicle. As a result, the vehicle control device 100 can increase a degree of freedom of the lane change control while improving safety.

Although the modes for carrying out the present invention have been described above by way of embodiments, the present invention is not limited to these embodiments at all, and various modifications and substitutions may be made without departing from the scope of the present invention.

### REFERENCE LIST

20 Finder
30 Radar
40 Camera
50 Navigation device
60 Vehicle sensor
70 Operation device
72 Operation detection sensor
80 Changeover switch
90 Travel driving force output device
92 Steering device
94 Brake device
100 Vehicle control device
102 Outside world recognition unit
104 Subject-vehicle position recognition unit
106 Action plan generation unit
110 Lane change control unit
111 Target position candidate setting unit
112 Other-vehicle position change estimation unit
113 Lane changeable period derivation unit
114 Control plan generation unit
115 Target position determination unit
116 Lane change possibility determination unit
117 Virtual vehicle setting unit
120 Travel control unit
122 Control switching unit
130 Storage unit
M Subject vehicle

What is claim is:

1. A vehicle control device comprising:
a detection unit configured to detect a position of a nearby vehicle traveling around a subject vehicle;
a target position candidate setting unit configured to set a lane change target position candidate in a target area as a candidate for a lane change target position set as a relative position with respect to the nearby vehicle traveling in an adjacent lane adjacent to a subject lane, by referring to a detection result of the detection unit, a number of lane change target position candidates varying according to a number of nearby vehicles traveling in the target area in the adjacent lane; and
a virtual vehicle setting unit configured to set a virtual vehicle obtained by virtually simulating the nearby vehicle on a lane that is a lane change destination of the subject vehicle,
wherein the target position candidate setting unit regards the virtual vehicle set by the virtual vehicle setting unit as the nearby vehicle and sets the lane change target position candidate within the target area.

2. The vehicle control device according to claim 1,
wherein the target position candidate setting unit sets the lane change target position candidate between the nearby vehicles traveling in the target area.

3. The vehicle control device according to claim 1,
wherein the target position candidate setting unit sets an area behind a front reference vehicle which is closest to the subject vehicle among the nearby vehicles traveling in the adjacent lane and traveling in front of a preceding vehicle traveling immediately in front of the subject vehicle in the subject lane, as the target area.

4. The vehicle control device according to claim 1,
wherein the target position candidate setting unit sets an area in front of a rear reference vehicle which is closest to the subject vehicle among the nearby vehicles traveling in the adjacent lane and traveling behind a following vehicle traveling immediately behind the subject vehicle in the subject lane, as the target area.

5. (canceled)

6. The vehicle control device according to claim 1, further comprising an estimation unit configured to estimate whether or not the nearby vehicle is about to change lanes,
wherein the virtual vehicle setting unit sets the virtual vehicle when the estimation unit estimates that the nearby vehicle is about to change lane to the lane that is the lane change destination of the subject vehicle.

7. The vehicle control device according to claim 6,
wherein the virtual vehicle setting unit sets the virtual vehicle when the estimation unit estimates that a nearby vehicle present in a lane different from the lane in which the subject vehicle travels is about to change a lane to the lane that is the lane change destination of the subject vehicle.

8. A vehicle control device comprising:
a detection unit configured to detect a position of a nearby vehicle traveling around a subject vehicle;
an estimation unit configured to estimate whether or not a nearby vehicle present on a lane different from a lane on which the subject vehicle travels detected by the detection unit is about to change a lane to a lane that is a lane change destination of the subject vehicle;
a virtual vehicle setting unit configured to set a virtual vehicle obtained by virtually simulating the nearby vehicle on the lane that is the lane change destination of the subject vehicle when the estimation unit estimates that the nearby vehicle is about to change lane; and
a target position candidate setting unit configured to set a lane change target position candidate in front of or behind the virtual vehicle as a candidate for a lane change target position set in an adjacent lane adjacent to a subject lane by referring to a detection result of the detection unit and the virtual vehicle set by the virtual vehicle setting unit.

9. A vehicle control method comprising:
detecting a position of a nearby vehicle traveling around a subject vehicle;
setting a lane change target position candidate in a target area as a candidate for a lane change target position set as a relative position with respect to the nearby vehicle traveling in an adjacent lane adjacent to a subject lane, by referring to a detection result, a number of lane change target position candidates varying according to a number of nearby vehicles traveling in the target area in the adjacent lane; and
setting a virtual vehicle obtained by virtually simulating the nearby vehicle on a lane that is a lane change destination of the subject vehicle,
wherein the virtual vehicle is regarded as the nearby vehicle and the lane change target position candidate is set within the target area.

10. A vehicle control program causing a computer of a vehicle control device including a detection unit configured to detect a position of a nearby vehicle traveling around a subject vehicle to execute:
setting a lane change target position candidate in a target area as a candidate for a lane change target position set as a relative position with respect to the nearby vehicle traveling in an adjacent lane adjacent to a subject lane, by referring to a detection result of the detection unit, a number of lane change target position candidates varying according to a number of nearby vehicles traveling in the target area in the adjacent lane; and
setting a virtual vehicle obtained by virtually simulating the nearby vehicle on a lane that is a lane change destination of the subject vehicle,
wherein the virtual vehicle is regarded as the nearby vehicle and the lane change target position candidate is set within the target area.

11. A vehicle control device comprising:
a detection unit configured to detect a position of a nearby vehicle traveling around a subject vehicle;
a target position candidate setting unit configured to set a target area for setting a candidate for a lane change target position set as a relative position with respect to the nearby vehicle traveling in an adjacent lane adjacent to a subject lane, by referring to a detection result of the detection unit, to an area being behind a front reference vehicle which is closest to the subject vehicle among the nearby vehicles traveling in the adjacent lane and traveling in front of a preceding vehicle traveling immediately in front of the subject vehicle in the subject lane, the area also being in front of a rear reference vehicle which is closest to the subject vehicle among the nearby vehicles traveling in the adjacent lane and traveling behind a following vehicle traveling immediately behind the subject vehicle in the subject lane; and
a virtual vehicle setting unit configured to set a virtual vehicle obtained by virtually simulating the nearby vehicle on a lane that is a lane change destination of the subject vehicle,
wherein the target position candidate setting unit regards the virtual vehicle set by the virtual vehicle setting unit as the nearby vehicle and sets the lane change target position candidate within the target area.

12. The vehicle control device according to claim 3,
wherein the target position candidate setting unit determines a point at a first predetermined distance forward of the subject vehicle to be a front side boundary of the target area when there is not at least one of the preceding vehicle and the front reference vehicle.

13. The vehicle control device according to claim 4,
wherein the target position candidate setting unit determines a point at a second predetermined distance behind the subject vehicle to be a rear side boundary of the target area when there is not at least one of the following vehicle and the rear reference vehicle.
